(19) United States
(12) Patent Application Publication
(10) Pub. No.: US 2024/0246877 A1
(43) Pub. Date: Jul. 25, 2024

(54) Methods of use for Muscodor albus strain producing volatile organic compounds

(71) Applicant: PRO FARM GROUP, INC., Davis, CA (US)

(72) Inventors: Brittany Pierce, Sacramento, CA (US); Elizabeth Henry, Sacramento, CA (US)

(21) Appl. No.: 18/526,759

(22) Filed: Dec. 1, 2023

Related U.S. Application Data
(60) Provisional application No. 63/429,513, filed on Dec. 1, 2022.

(51) Int. Cl. C05F 11/08; C05F 17/20

(52) U.S. Cl. CPC C05F 11/08; C05F 17/20

(57) ABSTRACT

Disclosed herein are methods for promoting plant growth by treatment, either directly or indirectly, with isolated Muscodor albus strain. A method for increasing an amount of beneficial microbes in a soil can include applying to the soil, to a plant grown in the soil, and/or a seed and/or a substrate used for growing a plant in the soil, an effective amount of a composition comprising Muscodor albus strain SA-13 (NRRL Accession No. B-50774) fermentation. Methods can promote plant growth, such as increate plant height and/or biomass, as well as induce earlier fruiting and flowering.

### CROSS REFERENCE TO RELATED APPLICATIONS

This application claims priority to U.S. Provisional application No. 63/429,513, filed Dec. 1, 2022 (“the '513 Provisional Application”). The contents of the '513 Application is incorporated herein in its entirety.

### INCORPORATION OF SEQUENCE LISTING

This application contains a Sequence Listing which has been submitted in XML format via PATENT CENTER and is hereby incorporated by reference in its entirety. Said ASCII copy is named 2024-02-29-61108-3000WOU1.xml, was created Feb. 29, 2024 and is 17 KB bytes in size.

### TECHNICAL FIELD

This disclosure relates generally to an isolated Muscodor albus strain producing volatile organic compounds (VOCs) as well as cultures of said strain and compositions, and metabolites derived from said strain or culture as well as methods of obtaining said compositions, metabolites and volatiles and their methods of use for promoting plant growth, including increasing height and/or biomass, and inducing earlier fruiting and flowering.

### SUMMARY

In various aspects, methods for promoting plant growth are disclosed.

A method of this disclosure includes increasing biomass of a plant by applying to the plant and/or seeds and/or substrate used for growing said plant an effective amount of a composition comprising Muscodor albus strain SA-13 (NRRL Accession No. B-50774) fermentation.

According to another aspect, a method of inducing early plant flowering includes the step of applying to the plant and/or seeds and/or substrate used for growing the plant an effective amount of a composition comprising a Muscodor albus strain.

Methods for increasing biomass of a plant can include applying a grain inoculated with Muscodor albus strain SA-13 to the substrate used for growing the plant. In other embodiments, the method includes placing the plant in communication with a substrate containing a grain inoculated with Muscodor albus strain SA-13, and/or treating the plant directly and/or indirectly with one or more volatile compounds produced by Muscodor albus strain SA-13.

According to another aspect, a method of increasing nitrogen in leaf tissues includes treating the leaf tissues directly and/or indirectly with one or more volatile compounds produced by a Muscodor albus strain.

According to another aspect, a method of upregulating genes in the systemic acquired resistance pathway includes applying a grain inoculated with a Muscodor albus strain to the substrate used for growing the plant. A method of upregulating genes in the jasmonic acid pathway can include applying a grain inoculated with Muscodor albus strain SA-13 to the substrate used for growing the plant.

According to yet another aspect, a method for increasing biomass of a plant includes applying to the plant and/or seeds and/or substrate used for growing said plant an effective amount of a composition comprising Muscodor albus strain SA-13 (NRRL Accession No. B-50774) fermentation, wherein said strain produces volatile compounds comprising 3-octanone, (-) aristolene, acetic acid 2-methylpropyl ester, propanoic acid 2-methyl-methyl ester, and propanoic acid 2-methyl-butyl ester.

Other aspects of the disclosed subject matter, as well as features and advantages of various aspects of the disclosed subject matter, should be apparent to those of ordinary skill in the art through consideration of the ensuing description, the accompanying drawings, and the appended claims.

### BRIEF DESCRIPTION OF THE DRAWINGS

In the drawings:

FIG. 1 provides a representation of an embodiment of an experimental set up to measure the effects of a Muscodor albus strain on lettuce.

FIG. 2 is a photograph of treated and untreated lettuce illustrating the effects of a Muscodor albus strain on growth.

FIG. 3 is a chart showing digital biomass of treated and untreated tomatoes.

FIG. 4 provides a representation of an embodiment of an experimental set-up to measure the effects of a Muscodor albus strain on tomatoes.

FIGS. 5-7 are photographs of treated and untreated tomatoes illustrating the effects of a Muscodor albus strain on growth.

FIGS. 8-10 are charts of average digital biomass of treated and untreated tomatoes illustrating the effects of a Muscodor albus strain on growth.

FIG. 11 shows a chart of the nitrogen level in leaf tissues for treated and untreated tomatoes.

FIG. 12 shows a chart of gene expression measured changes in the SAR pathway in treated and untreated tomatoes.

FIG. 13 shows a chart of gene expression measured changes in the jasmonic acid pathway in treated and untreated tomatoes.

FIG. 14 is a chart summarizing findings for expression levels of microbial pathways upregulated in the rhizosphere of plants treated directly or indirectly with a Muscodor albus strain.

FIG. 15 is a chart showing the number of genes overexpressed by the microbial community in the rhizosphere of plants treated directly or indirectly with a Muscodor albus strain.

FIG. 16 is a chart showing the relative abundance of various bacteria in the rhizosphere of treated and untreated plants.

FIG. 17 is another chart showing the relative abundance of various bacteria in the rhizosphere of treated and untreated plants.

FIG. 18 is a photograph of treated and untreated strawberry illustrating the effects of Muscodor albus on inducing flowering and fruiting.

FIG. 19 is a chart illustrating digital biomass over time for treated and untreated strawberry illustrating the effects of a Muscodor strain on digital biomass.

FIG. 20 is another chart illustrating digital biomass over time for treated and untreated strawberry illustrating the effects of a Muscodor strain on digital biomass.

FIG. 21 is a chart illustrating the number of fruits and flowers present at four weeks post-treatment for treated and untreated strawberry plants illustrating the effects of a Muscodor strain on inducing fruiting and flowering.

FIG. 22 shows a layout of field treatment for a broccoli study.

FIG. 23 shows plots chosen for analysis in a broccoli study.

FIGS. 24-26 show the total average biomass (in grams) of broccoli treated at a high, medium, and a low rate of different batch treatments of Muscodor albus formulations compared to a control.

FIGS. 27-29 show the total average head weight (in grams) of broccoli treated at a high, medium, and low rate of different batch treatments of Muscodor albus formulations compared to a control.

FIGS. 30-32 show the total Nitrogen content (%) in broccoli treated at a high, medium, and low rate of different batch treatments of Muscodor albus formulations compared to a control.

FIG. 33 shows the diversity index of soil samples taken from the rhizosphere of broccoli plants treated with 50 lbs/acre of various Muscodor albus batch formulations.

FIG. 34 is the ratio of fungi to bacteria in the rhizosphere soil samples of broccoli treated at 50 lbs/acre with different batch formulations of Muscodor albus.

FIG. 35 shows is the total living microbial biomass in ng/g of the rhizosphere soil sample taken from broccoli treated with 50 lbs/acre of different formulations of Muscodor albus.

FIG. 36 shows the breakdown of total fungi into arbuscular mycorrhizae and saprophytes in the rhizosphere soil samples taken from broccoli treated with 50 lbs/acre of different formulations of Muscodor albus.

### DETAILED DESCRIPTION

The endophytic fungus Muscodor albus (CZ-620) inhibits growth of a broad range of pathogenic fungi and bacteria, as well as some nematode and arthropod species. The inhibition is through a complex mixture of volatile organic compounds (VOCs) that M. albus secretes into the headspace of the culture. The volatile compounds emitted by M. albus and other closely related organisms in the genus consist of a combination of short-chain alcohols, organic acids, esters, ketones, and several aromatic hydrocarbons as monitored by gas chromatography-mass spectrometry (GC-MS). The compounds range from two to nine carbons and include both straight and branched-chain varieties. The larger aromatic products are predicted to be sesquiterpenes and derivatives of naphthalene and azulene. Although many fungal species have been reported to produce VOCs, none have demonstrated the wide-ranging bioactivity seen with isolates of M. albus.

Strains of M. albus may be used to additionally promote plant growth, including height, biomass, fruits, and flowers.

### Methods of Production

As noted above, compounds, metabolites or volatiles may be obtained, are obtainable or derived from an organism having one or more identifying characteristics of the Muscodor strain set forth above. The methods comprise cultivating these organisms and obtaining the compounds and/or compositions of the present invention by isolating these compounds from the culture of these organisms. In particular, the organisms are cultivated in nutrient medium using methods known in the art. The organisms may be cultivated by shake or non-shake cultivation, small scale or large-scale fermentation (including but not limited to continuous, batch, fed-batch, or solid state fermentations) in laboratory or industrial fermentation apparatus performed in suitable medium and under conditions allowing cell growth or on solid substrates such as agar. The cultivation may take place in suitable nutrient medium comprising carbon and nitrogen sources and inorganic salts, using procedures known in the art. Suitable media are available or may be available from commercial sources or prepared according to published compositions. In a particular embodiment and as set forth in the examples, the Muscodor albus strain may be cultivated on agar media such as potato dextrose agar (PDA) (D. Ezra et al., 2004. Microbiology, 150:4023) or in various grain media such as barley grains by inoculating the grains with the PDA plugs grown with the strain.

After cultivation, a supernatant, filtrate, volatile and/or extract of or derived from said Muscodor strain (e.g., Muscodor albus SA-13) may be used in formulating a composition. Alternatively, after cultivation, the compounds, volatiles and/or metabolites may be extracted from the culture broth. The detailed structure and method of making can be found in PCT/US2013/061531, and U.S. patent Ser. No. 10/869,482, which are incorporated herein by reference in their entireties.

As used herein, the term “a Muscodor strain” refers to any Muscodor strain from any Muscodor ssp. or any combination of Muscodor ssp. strains. For example, this can include but is not limited to Muscodor albus strain SA-13, MBI-601, 620, Ca22, E6, A3-5, N1-5, 205, N1-25, 100, N6, 21, GBA, 105, 5917A, and/or AR-30. In some embodiments, the Muscodor strain composition for application according to the present methods is prepared by isolation and applying the end of fermentation whole cell broth to a sterile grain, such as barley, etc. The methods and formulations in this disclosure can also be used with other Muscodor ssp. strains and these are contemplated herein. NRRL Accession No. B-50774 is one example of a strain that can be used, and strains may be prepared as described below or by other know method of preparing Muscodor ssp. strains.

The Muscodor ssp. strain may be prepared according to the following method. In one embodiment, SA-13 was originally isolated from the stem of the host plant Prosopis grandulosa Torr. (commonly known as honey mesquite) in southern Africa in June 2007 and identified by Dr. Gary Strobel by microscopic examination and ITS-5.8s sequencing. The MBI-601 material is prepared by applying the end of fermentation whole cell broth on to sterile barley by soaking barley in the end of fermentation whole cell broth. Pearled barley is sterilized by autoclaving for a minimum of 30 minutes and added to an excess of whole cell broth from the end of fermentation. The barley is allowed to soak in the whole cell broth for 18 hours, excess liquid is removed, and the barley is allowed to dry in a biosafety cabinet until the moisture level is below 14%. Batch PP211018-01 was prepared using this process with the addition of 1% w/w molasses and 1% w/w soy flour. Batch C-220303-02 was prepared using the process above with no additions. Other methods are also possible and contemplated herein, including the use of alternate Muscodor albus strains, the use of infested barley or other grains such as corn, rye, rice, wheat, etc.

For example, methods with shorter “soaking” time periods may be used. Time periods can typically be from about 5 minutes to about 2 hours, but shorter and longer time periods may be used as desired. Additionally, the grain can optionally be “seed treated” with a small amount of culture added direct to the grain (such as, about 2 mL culture per 30 grams of grain, or about 4 mL culture per 30 grams of grain).

### Compositions

Compositions may comprise barley or other grain treated with whole broth cultures, liquid or solid cultures, or suspensions of a Muscodor ssp. strain, such as a Muscodor albus strain or another Muscodor ssp. strain. In one embodiment, the composition comprises a Muscodor strain having at least one of the identifying characteristics of Muscodor albus SA-13 strain, as well as supernatant, filtrate and/or extract or one or more and more particularly a plurality of (i) metabolites, (ii) isolated compounds or (iii) volatiles derived from Muscodor albus SA-13 strain.

The compositions set forth above can be formulated in any manner. Non-limiting formulation examples include but are not limited to dried grains such as barley, corn, rye, rice, and wheat, emulsifiable concentrates (EC), wettable powders (WP), soluble liquids (SL), aerosols, ultra-low volume concentrate solutions (ULV), soluble powders (SP), microencapsulation, water dispersed granules (WDG), flowables (FL), microemulsions (ME), nano-emulsions (NE), etc. In any formulation described herein, percent of the active ingredient is within a range of 0.01% to 99.99%.

The compositions may be in the form of a liquid, gel or solid. A solid composition can be prepared by soaking a solid carrier in a solution of active ingredient(s) and drying the suspension under mild conditions, such as evaporation at room temperature or vacuum evaporation at 65° C. or lower. A solid composition can also be dried grains grown with the said strain. The composition may additionally comprise a surfactant to be used for the purpose of emulsification, dispersion, wetting, spreading, integration, disintegration control, stabilization of active ingredients, and improvement of fluidity, etc. In a particular embodiment, the surfactant is a non-phytotoxic non-ionic surfactant which preferably belongs to EPA List 4B. In another embodiment, the nonionic surfactant is polyoxyethylene (20) monolaurate. The concentration of surfactants may range between 0.1-35% of the total formulation, preferred range is 5-25%. The choice of dispersing and emulsifying agents, such as non-ionic, anionic, amphoteric and cationic dispersing and emulsifying agents, and the amount employed is determined by the nature of the composition and the ability of the agent to facilitate the dispersion of the compositions of the present invention.

The composition set forth above may be combined with another microorganism and/or pesticide (e.g., nematicide, bactericide, fungicide, insecticide). The microorganism may include but is not limited to an agent derived from Bacillus spp., Paecilomyces spp., Pasteuria spp. Pseudomonas spp., Brevabacillus spp., Lecanicillium spp., non-Ampelomyces spp., Pseudozyma spp., Streptomyces spp, Burkholderia spp, Trichoderma spp, Gliocladium spp. or other Muscodor strains. Alternatively, the agent may be a natural oil or oil-product having nematicidal, fungicidal, bactericidal and/or insecticidal activity (e.g., paraffinic oil, tea tree oil, lemongrass oil, clove oil, cinnamon oil, citrus oil, rosemary oil, pyrethrum).

Furthermore, the pesticide may be a single site anti-fungal agent which may include but is not limited to benzimidazole, a demethylation inhibitor (DMI) (e.g., imidazole, piperazine, pyrimidine, triazole), morpholine, hydroxypyrimidine, anilinopyrimidine, phosphorothiolate, quinone outside inhibitor, quinoline, dicarboximide, carboximide, phenylamide, anilinopyrimidine, phenylpyrrole, aromatic hydrocarbon, cinnamic acid, hydroxyanilide, antibiotic, polyoxin, acylamine, phthalimide, benzenoid (xylylalanine), a demethylation inhibitor selected from the group consisting of imidazole, piperazine, pyrimidine and triazole (e.g., bitertanol, myclobutanil, penconazole, propiconazole, triadimefon, bromuconazole, cyproconazole, diniconazole, fenbuconazole, hexaconazole, tebuconazole, tetraconazole), myclobutanil, and a quinone outside inhibitor (e.g., strobilurin). The strobilurin may include but is not limited to azoxystrobin, kresoxim-methoyl or trifloxystrobin. In yet another particular embodiment, the anti-fungal agent is a quinone, e.g., quinoxyfen (5,7-dichloro-4-quinolyl 4-fluorophenyl ether). The anti-fungal agent may also be derived from a Reynoutria extract.

The fungicide can also be a multi-site non-inorganic, chemical fungicide selected from the group consisting of chloronitrile, quinoxaline, sulphamide, phosphonate, phosphite, dithiocarbamate, chloralkythios, phenylpyridin-amine, and cyano-acetamide oxime.

As noted above, the composition may further comprise a nematicide. This nematicide may include but is not limited to chemicals such as organophosphates, carbamates, and fumigants, and microbial products such as avermectin, Myrothecium spp., Biome (Bacillus firmus), Pasteuria spp., Paecilomyces spp., and organic products such as saponins and plant oils.

In the case that the composition is applied to a seed, the composition may be applied to the seed as one or more coats prior to planting the seed using one or more seed coating agents including, but are not limited to, ethylene glycol, polyethylene glycol, chitosan, carboxymethyl chitosan, peat moss, resins and waxes or chemical fungicides or bactericides with either single site, multisite or unknown mode of action using methods known in the art.

The composition may be coated on to a conventional seed as noted above. In a particular embodiment, the compositions set forth above may be coated on a barley seed. The coated barley seed may further comprise protein-based ingredients such as milk, whey protein, high protein based flour from e.g., rice or wheat to enhance the storage life of said seeds. Alternatively, the composition may be coated on a genetically modified seed such as Liberty Link (Bayer CropScience), Roundup Ready seeds (Monsanto), or other herbicide resistant seed, and/or seeds engineered to be insect resistant, or seeds that are “pyrimaded” with more than one gene for herbicide, disease, and insect resistance or other stress, such as drought, cold, salt resistance traits.

### Uses

As noted above, the compositions set forth above may be applied using methods known in the art. These compositions may be applied to and around plants or plant parts, or applied to plants or the soil adjacent to the plants. For example, infested grains maybe placed in the soil adjacent to a plant. Plants are to be understood as meaning in the present context all plants and plant populations such as desired and undesired wild plants or crop plants (including naturally occurring crop plants).

The compositions can be placed in communication with plants and need not be directly touching the plants nor the substrate the plant is growing in. For example, “in communication” can mean that the compositions are in a separate container from the plant, but that the compositions can produce volatiles which may still reach the plant.

Crop plants can be plants which can be obtained by conventional plant breeding and optimization methods or by biotechnological and genetic engineering methods or by combinations of these methods, including the transgenic plants and including the plant cultivars protectable or not protectable by plant breeders' rights. Plant parts are to be understood as meaning all parts and organs of plants above and below the ground, such as shoot, leaf, flower and root, examples which may be mentioned being leaves, needles, stalks, stems, flowers, fruit bodies, fruits, seeds, roots, tubers and rhizomes. The plant parts also include, but are not limited to, harvested material, and vegetative and generative propagation material, for example cuttings, tubers, rhizomes, offshoots and seeds.

Plants that may be treated include but are not limited to: (A) Major edible food crops, which include but are not limited to (1) Cereals (African rice, barley, durum wheat, einkorn wheat, emmer wheat, finger millet, foxtail millet, hairy crabgrass, Indian barnyard millet, Japanese barnyard millet, maize, nance, oat, pearl millet, proso millet, rice, rye, sorghum, Sorghum spp., rye, spelt wheat); (2) Fruits (e.g., abiu, acerola, achacha, African mangosteen, alpine currant, ambarella, American gooseberry, American persimmon, apple, apricot, arazá, Asian palmyra palm, Asian pear, atemoya, Australian desert raisin, avocado, azarole, babaco, bael, banana, Barbados gooseberry, bergamot, betel nut, bignay, bilberry, bilimbi, binjai, biriba, bitter orange, black chokeberry, black mulberry, black sapote, blackberry, blue-berried honeysuckle, borojo, breadfruit, murmese grape, button mangosteen, cacao, calamondin, canistel, cantaloupe, cape gooseberry, cashew nut, cassabanana, cempedak, charichuelo, cherimoya, cherry, cherry of the Rio Grande, cherry plum, Chinese hawthorn, Chinese white pear, chokeberry, citron, cocona, coconut, cocoplum, coffee, coffee Arabica, coffee robusta, Costa Rica pitahaya, currants, custard apple, date, date-plum, dog rose, dragonfruit, durian, elderberry, elephant apple, Ethiopian eggplant, European nettle tree, European wild apple, feijoa, fig, gac, genipapo, giant granadilla, gooseberry, goumi, grape, grapefruit, great morinda, greengage, guava, hardy kiwi, hog plum, horned melon, horse mango, Indian fig, Indian jujube, jabuticaba, jackberry, jackfruit, Japanese persimmon, Japanese wineberry, jocote, jujube, kaffir lime, karanda, kei apple, kepel apple, key lime, kitembilla, kiwi fruit, korlan, kubal vine, kuwini mango, kwai muk, langsat, large cranberry, lemon, Liberian coffee, longan, loquat, lychee, malay apple, mamey sapote, mammee apple, mango, mangosteen, maprang, marang, medlar, melon, Mirabelle plum, miracle fruit, monkey jack, moriche palm, mountain papaya, mountain soursop, mulberry, naranjilla, natal plum, northern highbush blueberry, olive, otaheite gooseberry, oval kumquat, papaya, para guava, passion fruit, pawpaw, peach, peach-palm, pear, pepino, pineapple, pitomba Eugenia luschnathiana, pitomba talisia esculenta, plantain, plum, pomegranate, pomelo, pulasan, purple chokeberry, quince, rambutan, ramontchi, raspberry, red chokeberry, red currant, red mulberry, red-fruited strawberry guava, rhubarb, rose apple, roselle, safou, salak, salmonberry, santol, sapodilla, satsuma, seagrape, soncoya, sour cherry, soursop, Spanish lime, Spanish tamarind, star apple, starfruit, strawberry, strawberry guava, strawberry tree, sugar apple, Surinam cherry, sweet briar, sweet granadilla, sweet lime, tamarillo, tamarind, tangerine, tomatillo, tucuma palm, Vaccinium spp., velvet apple, wampee, watermelon, watery rose apple, wax apple, white currant, white mulberry, white sapote, white star apple, wolfberry (Lyceum barbarum, L. chinense), yellow mombin, yellow pitaya, yellow-fruited strawberry, guava, (3) Vegetables (e.g., ackee, agate, air potato, Amaranthus spp., American groundnut, antroewa, armenian cucumber, arracacha, arrowleaf elephant ear, arrowroot, artichoke, ash gourd, asparagus, avocado, azuki bean, bambara groundnut, bamboo, banana, Barbados gooseberry, beet, beet root, bitter gourd, bitter vetch, bitterleaf, black mustard, black radish, black salsify, blanched celery, breadfruit, broad bean, broccoli, Brussels sprout, Buck's horn plantain, buttercup squash, butternut squash, cabbage, caigua, calabash, caraway seeds, carob, carrot, cassabanana, cassava, catjang, cauliflower, celeriac, celery, celtuce, chard, chayote, chickpea, chicory, chilacayote, chili pepper (Capsicum annuum, C. baccatum, C. chinense, C. frutescens, C. pubescens), Chinese cabbage, Chinese water chestnut, Chinese yam, chives, chufa sedge, cole crops, common bean, common purslane, corn salad, cowpea, cress, cucumber, cushaw pumpkin, drumstick tree, eddoe, eggplant, elephant foot yam, elephant garlic, endive, enset, Ethiopian eggplant, Florence fennel, fluted gourd, gac, garden rocket, garlic, geocarpa groundnut, Good King Henry, grass pea, groundnut, guar bean, horse gram, horseradish, hyacinth bean, ice plant, Indian fig, Indian spinach, ivy gourd, Jerusalem artichoke, jacamar, jute, kale, kohlrabi, konjac, kurrat, leek, lentil, lettuce, Lima bean, lotus, luffa, maca, maize, mangel-wurzel, mashua, moso bamboo, moth bean, mung bean, napa cabbage, neem, oca, okra, Oldham's bamboo, olive, onion, parsnip, pea, pigeon pea, plantain, pointed gourd, potato, pumpkins, squashes, quinoa, radish, rapeseed, red amaranth, rhubarb, ribbed gourd, rice bean, root parsley, runner bean, rutabaga, sago palm, salsify, scallion, sea kale, shallot, snake gourd, snow pea, sorrel, soybean, spilanthes, spinach, spinach beet, sweet potato, taro, tarwi, teasle gourd, tepary bean, tinda, tomato, tuberous pea, turnip, turnip-rooted chervil, urad bean, water caltrop trapa bicornis, water caltrop trapa natans, water morning slory, watercress, welsh onion, west African okra, west Indian gherkin, white goosefoot, white yam, winged bean, winter purslane, yacón, yam, yard-long bean, zucchinietables); (4) Food crops (e.g., abiu, acerola, achacha, ackee, African mangosteen, African rice, agate, air potato, alpine currant, Amaranthus app., Ambarrella, American gooseberry, American groundnut, American persimmon, antroewa, apple, apricot, arazá, Armenian cucumber, arracacha, arrowleaf elephant ear, arrowroot, artichoke, ash gourd, Asian palmyra palm, Asian pear, asparagus, atemoya, Australian desert raisin, avocado, azarole, azuki bean, babaco, bael, bambara groundnut, bamboo, banana, barbados gooseberry, barley, beet, beetroot, bergamot, betel nut, bignay, bilberry, bilimbi, binjai, biriba, bitter gourd, bitter orange, bitter vetch, bitterleaf, black chokeberry, black currant, black mulberry, black mustard, black radish, black salsify, black sapote, blackberry, blanched celery, blue-berried honeysuckle, borojó, breadfruit, broad bean, broccoli, Brussels sprout, Buck's horn plantain, buckwheat, Burmese grape, buttercup squash, butternut squash, button mangosteen, cabbage, cacao, caigua, calabash, calamondin, canistel, cantaloupe, cape gooseberry, caraway seeds, carob, carrot, cashew nut, cassava, catjang, cauliflower, celeriac, celery, celtuce, cempedak, chard, charichuelo, chayote, cherimoya, cherry, cherry of the Rio Grande, cherry plum, chickpea, chicory, chilacayote, chili pepper (Capsicum annuum, C. baccatum, C. chinense, C. frutescens, C. pubescens), Chinese cabbage, Chinese hawthorn, Chinese water chestnut, Chinese white pear, Chinese yam, chives, chokeberry, chufa sedge, citron, cocona, coconut, cocoplum, coffee, coffee (Arabica and Robusta types), cole crops, common bean, common purslane, corn salad, Costa Rica pitahaya, cowpea, cress, cucumber, currants, cushaw pumpkin, custard apple, date, date-plum, dog rose, dragonfruit, drumstick tree, durian, durum wheat, eddoe, eggplant, einkorn wheat, elderberry, elephant apple, elephant foot yam, elephant garlic, emmer wheat, endive, enset, Ethiopian eggplant, European nettle tree, European wild apple, feijoa, fig, finger millet, Florence fennel, fluted gourd, foxtail millet, gac, garden rocket, garlic, genipapo, geocarpa groundnut, giant granadilla, good king henry, gooseberry, goumi, grape, grapefruit, grass pea, great morinda, greengage, groundnut, grumichama, guar bean, guava, hairy crabgrass, hardy kiwi, hog plum, horned melon, horse gram, horse mango, horseradish, hyacinth bean, iceplant, Indian barnyard millet, Indian fig, Indian jujube, Indian spinach, ivy gourd, jabuticaba, jackalberry, jackfruit, jambul, Japanese barnyard millet, Japanese persimmon, Japanese wineberry, Jerusalem artichoke, jocote, jujube, jute, kaffir lime, kale, karanda, kei apple, kepel apple, key lime, kitembilla, kiwifruit, kohlrabi, konjac, korlan, kubal vine, kurrat, kuwini mango, kwai muk, langsat, large cranberry, leek, lemon, lentil, lettuce, Liberian coffee, lima bean, longan, loquat, lotus, luffa, lychee, maca, maize, malay apple, mamey saptoe, mammee apple, mangel-wurzel, mango, mangosteen, maprang, marang, mashua, medlar, melon, Mirabelle plum, miracle fruit, monk fruit, monkey jack, moriche palm, moso bamboo, moth bean, mountain papaya, mountain soursop, mulberry, mung bean, mushrooms, nance, napa cabbage, naranjilla, natal plum, neem, northern highbush blueberry, oat, oca, oil palm, okra, old man's bamboo, olive, onion, orange, otaheite gooseberry, oval kumquat, papaya, para guava, parsnip, passionfruit, pawpaw, pea, peach, peach-palm, pear, pearl millet, pepino, pigeon pea, pineapple, Pitomba (Eugenia luschnathiana, Talisia esculenta), plantain, plum, pointed gourd, pomegranate, pomelo, potato, proso millet, pulasan, pumpkins and squashes, purple chokeberry, quince, quinoa, radish, rambutan, ramontchi, rapeseed, raspberry, red amaranth, red chokeberry, red currant, red mulberry, red-fruited strawberry guava, rhubarb, ribbed gourd, rice, rice bean, root parsley, rose apple, roselle, runner bean, rutabaga, rye, safou, sago palm, salak, salmonberry, salsify, santol, sapodilla, Satsuma, scallion, sea kale, seagrape, shallot, snake gourd, snow pea, soncoya, sorghum, Sorghum spp., sorrel, sour cherry, soursop, soybean, Spanish lime, Spanish tamarind, spelt wheat, spilanthes, spinach, spinach beet, star apple, starfruit, strawberry, strawberry guava, strawberry tree, sugar apple, sugar beet, sugarcane, surinam cherry, sweet briar, sweet granadilla, sweet lime, sweet potato, tamarillo, tamarind, tangerine, taro, tarwi, teasle gourd, tef, tepary bean, tinda, tomatillo, tomato, tuberous pea, tucuma palm, turnip, turnip-rooted chervil, urad bean, Vaccinium spp., velvet apple, wampee, water caltrop (Trapa bicornis, T. natans), water morning glory, watercress, watermelon, watery rose apple, wax apple, welsh onion, west African okra, west Indian gherkin, wheat, white currant, white goosefoot, white mulberry, white sapote, white star apple, white yam, winged bean, winter purslane, wolfberry (Lycium barbarum, L. chinense), yacón, yam, yangmei, yard-long bean, yellow mombin, yellow pitaya, yellow-fruited strawberry guava, zucchini; (B) Other edible crops, which includes but is not limited to (1) Herbs (e.g., Absinthium, alexanders, basil, bay laurel, betel nut, camomile, chervil, chili pepper (Capsicum annuum, C. baccatum, C. chinense, C. frutescens, C. pubescens), chili peppers, chives, cicely, common rue, common thyme, coriander, cress, culantro, curly leaf parsley, dill, epazote, fennel, flat leaf parsley, ginseng, gray santolina, herb hyssop, holy basil, hop, jasmine, kaffir lime, lavender, lemon balm, lemon basil, lemon grass, lovage, marjoram, mint, oregano, parsley, peppermint, perilla, pot marigold, rooibos, rosemary, sage, shiny-leaft buckthorn, sorrel, spearmint, summer savory, tarragon, Thai basil, valerian, watercress, wild betel, winter savory, yerba mate); (2) Spices (e.g., ajowan, allspice, anise, bay laurel, black cardamom, black mustard, black pepper, caper, caraway seeds, cardamom, chili pepper (Capsicum annuum, C. baccatum, C. chinense, C. frutescens, C. pubescens), chili peppers, cinnamon, clove, common juniper, coriander, cumin, fennel, fenugreek, garlic, ginger, kaffir lime, liquorice, nutmeg, oregano, pandan, parsley, saffron, star anise, turmeric, vanilla, white mustard); (2) Medicinal plants (e.g., absinthium, alfalfa, aloe vera, anise, artichoke, basil, bay laurel, betel leat, betel nut, bilberry, black cardamom, black mustard, black pepper, blue gum, borojo, chamomile, caper, cardamom, castor bean, chili peppers, Chinese yam, chives, cola nut, common jasmine, common lavender, common myrrh, common rue, cilantro, cumin, dill, dog rose, epazote, fennel, fenugreek, gac, garlic, ginger, gray santolina, gum Arabic, herb hyssop, holy basil, horseradish, incense tree, lavender, lemon grass, liquorice, lovage, marijuana, marjoram, monk fruit, neem, opium, oregano, peppermint, pot marigold, quinine, red acacia, red currant, rooibos, safflower, sage, shiny-leaf buckthorn, sorrel, spilanthes, star anise, tarragon, tea, turmeric, valerian, velvet bean, watercress, white mustard, white sapote, wild betel, wolfberry (Lycium barbarum, L. chinense), yerba mate); (3) Stimulants (e.g., betel leaf, betel nut, cacao, chili pepper (Capsicum annuum, C. baccatum, C. chinense, C. frutescens, C. pubescens), chili peppers, coffee, coffee (Arabica, Robusta), cola nut, khat, Liberian coffee, tea, tobacco, wild betel, yerba mate); (4) Nuts (e.g., almond, betel nut, Brazil nut, cashew nut, chestnut, Chinese water chestnut, coconut, cola nut, common walnut, groundnut, hazelnut, Japanese stone oak, macadamia, nutmeg, paradise nut, pecan nut, pistachio nut, walnut); (5) Edible seeds (e.g., black pepper, Brazil nut, chilacayote, cola nut, fluted gourd, lotus, opium, quinoa, sesame, sunflower, water caltrop (Trapa bicornis, T. natans)); (6) Vegetable oils (e.g., black mustard, camelina, castor bean, coconut, cotton, linseed, maize, neem, Niger seed, oil palm, olive, opium, rapeseed, safflower, sesame, soybean, sunflower, tung tree, turnip); (7) Sugar crops (e.g., Asian palmyra palm, silver date palm, sorghum, sugar beet, sugarcane); (8) Pseudocereals (e.g., Amaranthus spp., buckwheat, quinoa, red amaranth); (9) Aphrodisiacs (e.g., borojo, celery, durian, garden rocket, ginseng, maca, red acacia, velvet bean); (C) Non food categories, including but not limited to (1) forage and dodder crops (e.g., agate, alfalfa, beet, broad bean, camelina, catjang, grass pea, guar bean, horse gram, Indian barnyard millet, Japanese barnyard millet, lespedeza, lupine, maize, mangel-wurzel, mulberry, Niger seed, rapeseed, rice bean, rye); (2) Fiber crops (e.g., coconut, cotton, fique, hemp, henequen, jute, kapok, kenaf, linseed, manila hemp, New Zealand flax, ramie, roselle, sisal, white mulberry); (3) Energy crops (e.g., blue gum, camelina, cassava, maize, rapeseed, sorghum, soybean, Sudan grass, sugar beet, sugarcane, wheat); (4) Alcohol production (e.g., barley, plum, potato, sugarcane, wheat, sorghum); (5) Dye crops (e.g., chay root, henna, indigo, old fustic, safflower, saffron, turmeric); (6) Essential oils (e.g., allspice, bergamot, bitter orange, blue gum, chamomile, citronella, clove, common jasmine, common juniper, common lavender, common myrrh, field mint, freesia, gray santolina, herb hyssop, holy basil, incense tree, jasmine, lavender, lemon, marigold, mint, orange, peppermint, pot marigold, spearmint, ylang-ylang tree); (6) Green manures (e.g., alfalfa, clover, lacy Phacelia, sunn hemp, trefoil, velvet bean, vetch); (7) Erosion prevention (e.g., bamboo, cocoplum); (8) Soil improvement (e.g., lupine, vetch); (9) Cover crops (e.g., Alfalfa, lacy Phacelia, radish); (10) Botanical pesticides (e.g., jicama, marigold, neem, pyrethrum); (11) Cut flowers (e.g., carnation, chrysanthemum, daffodil, dahlia, freesia, gerbera, marigold, rose, sunflower, tulip); (12) Ornamental plants (e.g., African mangosteen, aloe vera, alpine currant, aster, black chokeberry, breadfruit, calamondin, carnation, cassabanana, castor bean, cherry plum, chokeberry, chrysanthemum, cocoplum, common lavender, crocus, daffodil, dahlia, freesia, gerbera, hyacinth, Japanese stone oak, Jasmine, lacy Phacelia, lotus, lupine, marigold, New Zealand flax, opium, purple chokeberry, ramie, red chokeberry, rose, sunflower, tulip, white mulberry); (D) Trees which include but are not limited to abelia, almond, apple, apricot, arborvitae nigra American, arborvitae, ash, aspen, azalea, bald cypress, beautush, beech, birch, black tupelo, blackberry, blueberry, boxwood, buckeye, butterfly bush, butternut, camellia, catalpa, cedar, cherry, chestnut, coffee tree, crab trees, crabapple, crape myrtle, cypress, dogwood, Douglas fir, ebony, elder American, elm, fir, forsythia, ginkgo, goldenraintree, hackberry, hawthorn, hazelnut, hemlock, hickory, holly, honey locust, horse chestnut, hydrangea, juniper, lilac, linden, magnolia, maple, mock orange, mountain ash, oak, olive, peach, pear, pecan, pine, pistachio, plane tree, plum, poplar, pivet, raspberry, redbud, red cedar, redwood, rhododendron, rose-of-Sharon, sassafras, sequoia, serviceberry, smoke tree, soapberry, sourwood, spruce, strawberry tree, sweet shrub, sycamore, tulip tree, ciborium, walnut, weasel, willow, winterberry, witch-hazel, zelkova; (E) Turf which includes but is not limited to Kentucky bluegrass, tall fescue, Bermuda grass, zoysia grass, perennial ryegrass, fine fescues (e.g.; creeping red, chewings, hard, or sheep fescue).

Treatment of the plants and plant parts with the compositions set forth above may be carried out directly or by allowing the compositions to act on their surroundings, habitat, or storage space. For example, where infested grains are placed adjacent to a plant, the emitted VOCs adjacent to the plant may act on their surroundings. The compositions may also be applied to the soil using methods known in the art. These include but are not limited to (a) drip irrigation or chemigation; (b) soil incorporation; (c) seed treatment. For example, a Muscodor albus strain may be incorporated into the soil at the desired rate. The compositions, cultures, supernatants, metabolites and compounds set forth above may be used as growth promoters, alone or in combination with one or more pesticidal substances set forth above and applied to plants, plant parts, substrate for growing plants or seeds set forth above.

The compositions, cultures, supernatants, metabolites and compounds set forth above may be combined with other enhancing compounds for the said compositions such as, but not limited to, amino acids, chitosan, chitin, starch, hormones, minerals, synergistic microbes to increase efficacy and promote benefits to plants.

### EXAMPLES

Study 1. Effect of Muscodor albus on Lettuce Growth Promotion

Four treatment groups in two separate environments were run to determine the effects of Muscodor albus on lettuce growth promotion. For group 1, an untreated control, the plants were placed in a separate environment (plant growth chambers obtained from Conviron® were used) to eliminate contact with plant or M. albus volatiles. For each treatment group, nine pots (3.5″) were filled with a 50:50 mixture of autoclaved sand and standard potting soil mix (45% topsoil-riverwash sandy soil, 5% Vermiculite, 35% Peat Moss, 15% Perlite). The following treatments were incorporated into the soil for each treatment group:

| Conviron 1: Group 1 | Conviron 2: Group 2 | Conviron 2: Group 3 | Conviron 2: Group 4 |
|---|---|---|---|
| (“UTC”) | (“MBI-601T-Adjacent”) | (“MBI-601 Low rate”) | (“MBI-601 high rate”) |
| sterile barley (blank), | sterile barley (blank), | Barley with MBI-601 | Barley with MBI-601 |
| with no Muscodor | with no Muscodor | (C-220303-02) at a | (C-220303-02) at a |
| albus present | albus present | rate of 0.12 g/pot | rate of 1.86 g/pot |

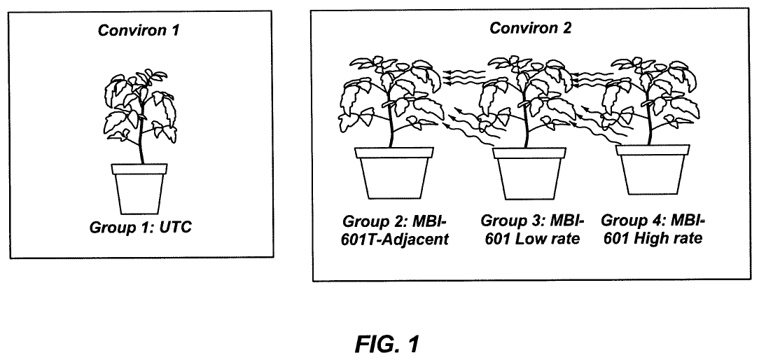

The additions were incorporated into the soil, saturated with water and placed into a Conviron plant growth chamber (28° C. with 16 hours light and 8 hours dark). Treatments were separated into separate environments to prevent crosstalk. Conviron 1 contained the Group 1 UTC plants and the Conviron 2 contained the Group 2 treated-adjacent plants along with the Group 3 treated (low rate) and the Group 4 treated (high rate). FIG. 1 illustrates the experimental set up of Conviron 1 and Conviron 2. After a 1-week incubation, lettuce (Bubba) was direct seeded into each pot and thinned to one plant per pot seven days post-seeding.

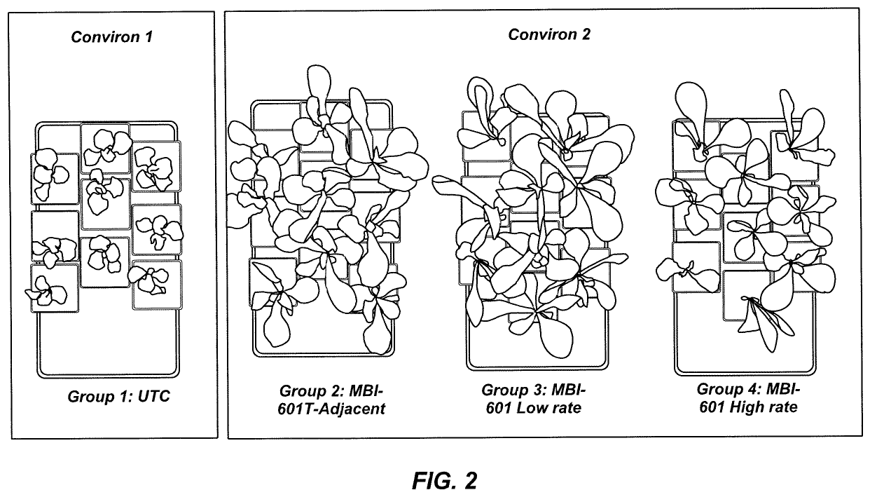

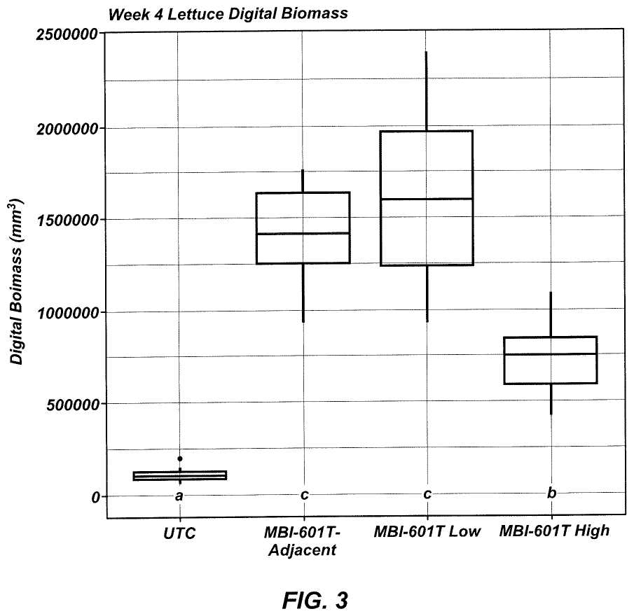

One of the purposes of this experiment was to measure the overall growth effects of a Muscodor albus strain on lettuce (while Muscodor albus MBI-601 strain was used for this particular experiment, other strains can also be used). FIG. 2 shows a photo of the plants in each of Groups 1-4 after two weeks. FIG. 3 shows a chart of the biomass (in mm³) all plants in Groups 1-4 after 4 weeks. The plants were non-destructively scanned using the Phenospex PlantEye multispectral 3D scanner two- and four weeks post-planting. As seen in the figures and data presented in FIGS. 2 and 3, plants directly exposed to MBI-601 (Group 3 “MBI-601 Low rate” and Group 4 “MBI-601 high rate”) or indirectly exposed to MBI-601 (Group 2 “MBI-601T-Adjacent”) exhibited growth promotion and increased biomass compared to plants not exposed to MBI-601 (Group 1 “UTC”).

Study 2. Effect of Muscodor albus on Tomato Growth and Gene Pathway Analysis

Four treatment groups in three separate environments were run to determine the effects of Muscodor albus on tomato growth promotion and gene pathways. For each treatment group, six pots (3.5″) were filled with standard potting soil mix (45% Topsoil-riverwash sandy soil, 5% Vermiculite, 35% Peat Moss, 15% Perlite) and tomato Roma seeds were planted. Plants were thinned 18 days post-germination and transferred to a plant growth chamber (16 hr light at 28° C., 70% humidity and 8 hr dark at 22° C. 70% humidity) to acclimated for 7 days. After 7 days, the following treatments were incorporated into the soil for each treatment group:

| | Conviron | Conviron 3: | |
|---|---|---|---|
| Conviron 1: UTC | 2: Indirect | 601T-Adjacent | Conviron 3: 601T |
| 5 g of | 5 g of | 5 g of | MBI-601 |
| uninoculated | uninoculated | uninoculated | (PP211018-01) |
| barley added | barley (no | barley added | was added to |
| per pot (no | Muscodor albus | per pot (no | each pot next |
| Muscodor albus | present) added | Muscodor | to the Indirect |
| present) | to Indirect | albus present) | pots at a rate |
| | treatment pots | | of 5 g/pot |
| | with tomato plant | | |
| | MBI-601 | | |
| | (PP211018-01) | | |
| | was added to | | |
| | each pot next | | |
| | to the Indirect | | |
| | pots at a rate | | |
| | of 5 g/pot | | |

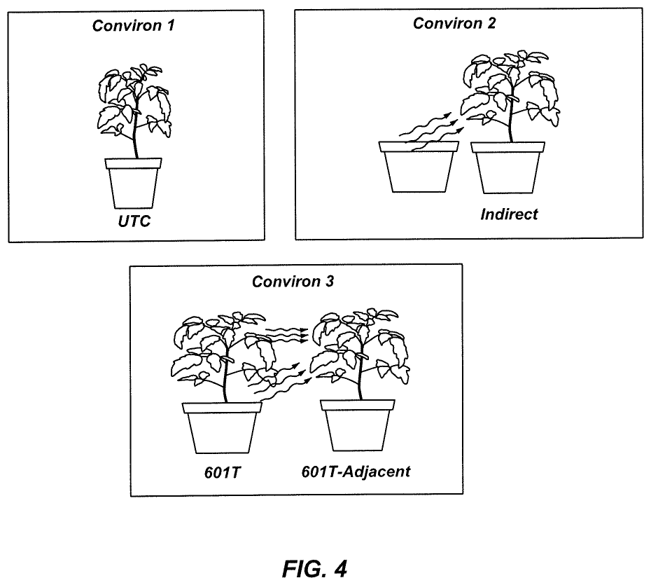

FIG. 4 illustrates the experimental set up of Convirons 1-3. For the Indirect treatment in Conviron 2, plants were not directly treated. A separate, treated pot was placed next to the plants in pots and volatiles produced by the treated pot contact the Indirect treatment plants through the leaves only.

For the treatments in Conviron 3, two sets of plants are measured. A first set (601T) treats plants directly with MBI-601. The volatiles may trigger the plant through the roots or foliar tissue. A second set (601T-Adjacent) leaves plants untreated but located next to treated plants (601T) in the same Conviron. These plants may be triggered by MBI-601 volatiles (similar to indirect) or plant-to-plant communication from the adjacent treated plants.

MBI-601 from batch PP211018-01 was used for the MBI-601 treatment. While MBI-601 was used for this particular experiment, it will be appreciated that other strains of Muscodor albus could also be used. MBI-601 was hydrated to field capacity. The plants were analyzed with the Phenospex PlantEye multispectral 3D scanner 3, 6 and 10 days post-treatment in replicate one and 3, 6 and 11 days post-treatment in replicate two. Additionally, the fourth compound leaf from growing tip was collected and submitted to Devalle Laboratory (Davis, CA) for plant tissue nutrient analysis.

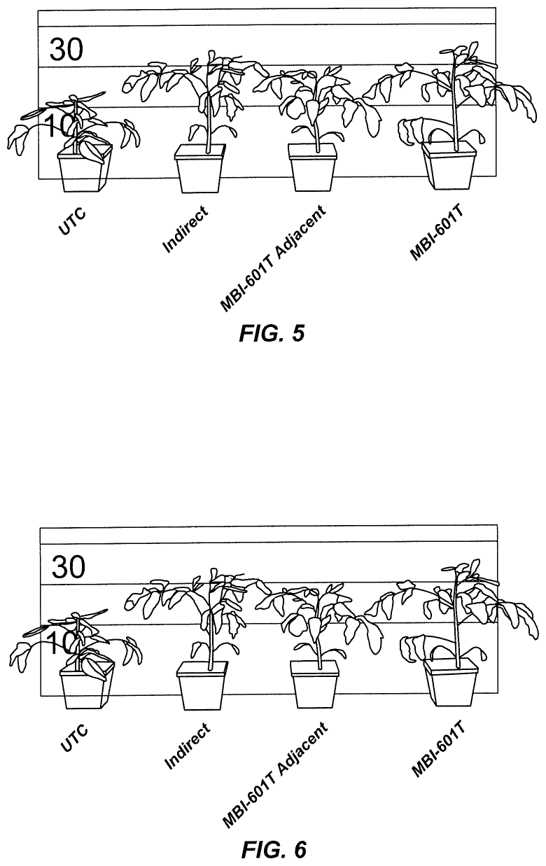

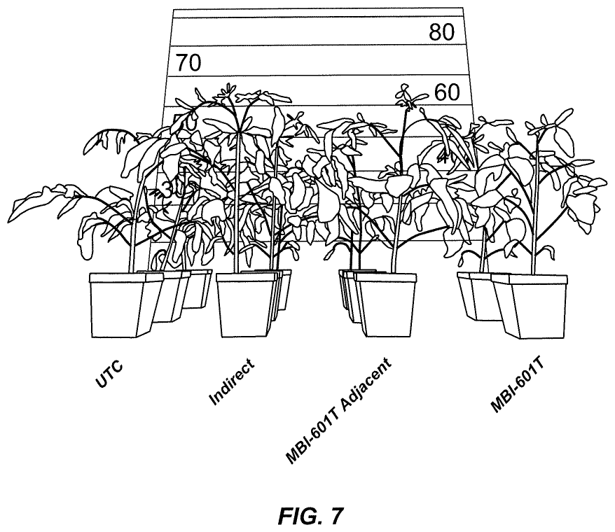

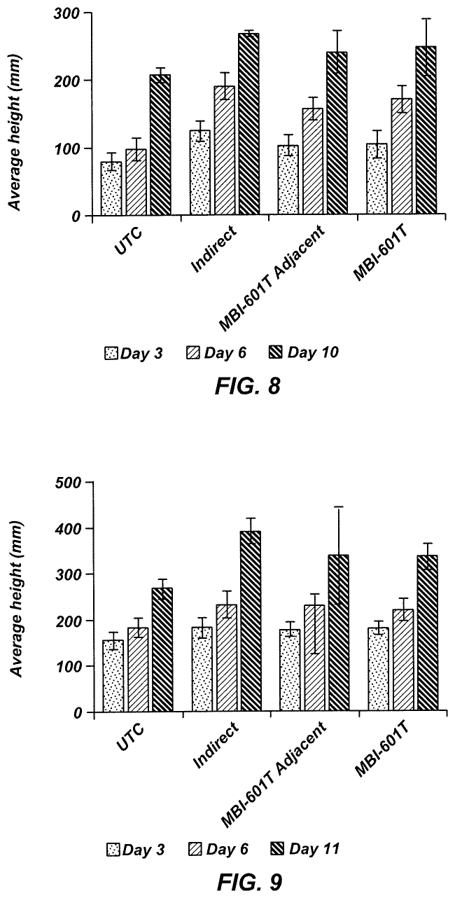

One of the purposes of this experiment was to measure the overall growth effects of Muscodor albus on tomato. FIG. 5 shows a photo of the plants in each of the treatment groups for replicate 1, 3 days post-treatment. FIG. 6 shows a photo of the plants in each of the treatment groups for replicate 1, 6 days post-treatment, and FIG. 7 shows a photo of the plants in each of the treatment groups for replicate 1, 10 days post-treatment. FIG. 8 shows a chart of the average height for each treatment group for replicate 1 for each of 3, 6, and 10 days post-treatment. FIG. 9 shows a chart of the average height for each treatment group for replicate 2 for each of 3, 6, and 10 days. FIG. 10 shows a chart of the average biomass (in mm³) for each treatment group in replicate 1 for each of 3, 6, and 10 days post-treatment. Levels of nitrogen in leaves for each of the treatment groups were also measured and 3 and 6 days. FIG. 11 shows a chart of the nitrogen level in leaf tissues for each treatment group and 3 and 6 days post-treatment.

As seen in the figures and data presented in FIGS. 5 through 10, plants directly exposed to MBI-601 (“MBI-601”) or indirectly exposed to MBI-601 (“Indirect” and “MBI-601T Adjacent”) exhibited growth promotion and increased biomass compared to plants not exposed to MBI-601 (“UTC”). MBI-601 treated plants also have a higher level of nitrogen in leaf tissues.

Another purpose of this experiment was to measure the effects of MBI-601 on various gene pathways in tomato, including genes in the systemic acquired resistance (SAR) pathway and the jasmonic acid pathway. SAR is a long-distance signaling mechanism that provides broad spectrum, lasting resistance to secondary infections throughout a plant. This unique feature makes SAR a desirable trait in crop production. Jasmonic acid and jasmonates (JAs) are also involved in the regulation of important growth and developmental processes. JAs can effectively mediate responses against environmental stresses by inducing a series of genes expression.

Tissue samples (100 mg) for qPCR-based gene expression analysis were harvested from plants in experiment replicate one and flash-frozen in liquid nitrogen at the 3, 6 and 10 day timepoints. Total RNA was extracted using the Qiagen RNAeasy Plant Mini Kit (Germany). Total RNA (1 ug) was converted to cDNA with the High Capacity cDNA Reverse Transcription Kit (Applied Biosystems, Waltham, MA). Gene expression analysis was carried out on cDNA with primers for the gene targets listed in table 1. Quantitative reverse transcription was conducted with Quantabio (Beverly, MA) PerfeCTa SYBR Green FastMix (10 ul PerfeCTa SYBR Green FastMix, 2 ul cDNA, 250 mM forward primer, 250 mM reverse primer, water to 20 ul final volume) on a BioRad CFX96 thermocycler (Hercules, CA) with the following cycling conditions (initial denaturation 30 s 95° C.; 40 cycles of 5 s 95° C. and 30 s 60° C.; 10 min 72° C. elongation and melt curve of 65°−95° C. in 0.5° C. increments). Gene expression analysis was conducted using the 2^{-ΔΔCt} method (Livak and Schmittgen 2001).

TABLE 1
Primer sequences for target genes

| | | Forward | Reverse |
|---|---|---|---|
| Gene | | Primer | Primer |
| ID | Gene name | Sequence | Sequence |
| PR-1 | Pathogenesis- | AACGCTCACAA | AAGGTCCACCAG |
| | related protein 1 | TGCAGCTCGT | AGTGTTGC |
| NPR1 | Nonexpressor of | GGGAAAGATAG | GTCCACACAAAC |
| | pathogenesis | CAGCACG | ACACACATC |
| | related genes 1 | | |
| Chi | Chalcone isomerase | CGCAGGGAATA | AGCACTCTCTTC |
| | | GAGGTTTGGAG | CAAGTACACACC |
| Chs | Chalcone synthase | GCTTAGTACCA | TGGAGCACAACA |
| | | CAGGTGAAGGC | GTCTCAACAG |
| PR-5 | Pathogenesis- | GCAACAACTGT | AGACTCCACCAC |
| | related protein 5 | CCATACACC | CAATCACC |
| LoxD | linoleate 13S- | GACTGGTCCAA | ATGTGCTGCCAAT |
| | lipoxygenase 3-1 | GTTCACGATCC | ATAAATGGTTCC |
| Opr3 | 12-Oxophytodienoate | TTGGCTTAGCA | TACGTATCGTGG |
| | reductase 3 | GTTGTTGAAAG | CTGTGTTACA |
| Lsm7* | U6 snRNA-associated | GGTGGAAGACA | CGTCTGGCTGAA |
| | Sm-like protein | AGTGGTTGGAA | CAAAAGGATTGG |
| | LSm7 | CAC | |
| TIP41* | TAP42-interacting | ATGGAGTTTTT | GCTGCGTTTCTG |
| | protein | GAGTCTTCTGC | GCTTAGG |

*Lsm7 and TIP41 are reference genes for normalization

Tissue samples (100 mg) for RNAseq analysis were harvested from plants in replicate two and flash-frozen in liquid nitrogen at the 3, 6 and 10 day timepoints. Total RNA was extracted using the Qiagen RNAeasy Plant Mini Kit (Germany). The mRNA was separated from total RNA using the NEBnext Poly(A) mRNA magnetic isolation module in conjunction with the NEBnext Ultra II Directional RNA Library prep kit (Ipswich, MA). Sequencing libraries were sequenced on a single NovaSeq S4 lane. Total yield was 1.1 billion reads (approximately 22 million reads/sample) and over 341 Gb. The SL3.0 Solanum lycopersicum genome assembly and annotation was downloaded from RefSeq (accession GCF_000188115.4) and used as a reference. Data was processed using an in-house analysis pipeline with the following packages: Trimmomatic, Bowtie2, and Subread feature, Counts to trim adapter sequences, map reads to the reference genome, and generate a table of counts for each gene in the genome, respectively. Differential expression analysis was conducted in R using the packages EdgeR and Limma. Genes were determined significantly over- or under-expressed using a cutoff of log 2>1 or <−1 fold change and a p-value of 0.1. TopGO was utilized for Gene Ontology analysis, which determines if functional groups of genes are enriched. The p-values for GO terms were determined by the elimKS method, and GO terms were determined significantly up- or down-regulated using a p-value cutoff of 0.05.

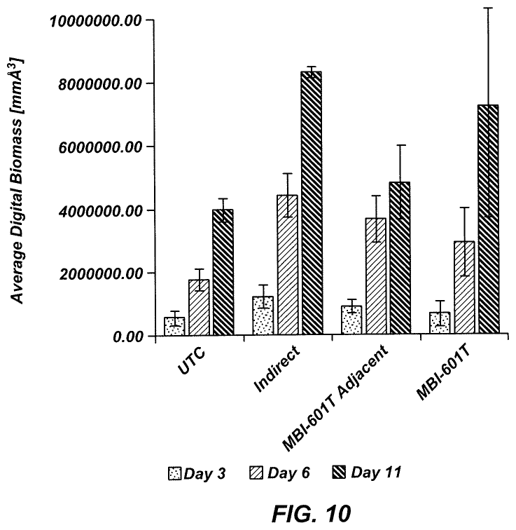

FIG. 12 shows a chart of the measured changes of gene expression for the PR-1, NPR1, Chi, Ch5, and PR-5 genes in the systemic acquired resistance pathway, for each of the treatment groups, at 3, 6, and 10 days post-treatment for replicate 2.

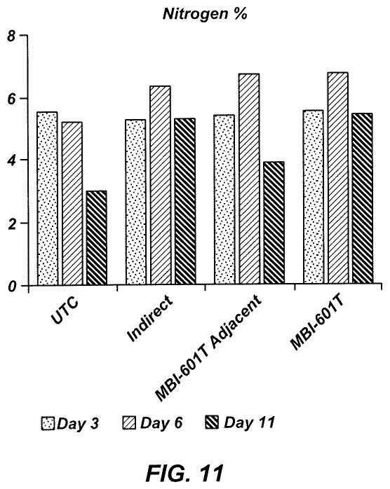

FIG. 13 shows a chart of the measured changes of gene expression for the LoxD and Opr3 genes in the jasmonic acid pathway, for each of the treatment groups, at 3, 6, and 10 days post-treatment for replicate 2.

Another purpose of this experiment was to measure the effects of Muscodor albus on the microbiome of the treated plants. Particularly, expression levels of microbial pathways upregulated in Muscodor albus treated plants and genes overexpressed in the microbial community of the rhizosphere of Muscodor albus treated plants.

Rhizosphere microbes were isolated from tomato plants 14 days post-treatment and immediately frozen. In brief, tomato roots were delicately removed from the soil, loose soil removed and sonicated three times in sterile 1× Phosphate-buffered saline. The soil from each sonication step was collected by centrifugation, pooled and flash frozen in liquid nitrogen. Total RNA was extracted from the soil pellet using the Qiagen RNeasy PowerSoil Total RNA kit (Germany). Illumina sequencing libraries were prepared from ribosomal-depleted RNA and sequenced on the Illumina NovaSeq platform. Data was processed with MG-RAST (mg-rast.org) to map reads to the various databases (KEGG, Subsystems, Silva SSU, Refseq). EdgeR was utilized to identify significantly up regulated pathways in the rhizosphere using a cutoff of log 2FC>1, p<0.05 and FDR<0.05.

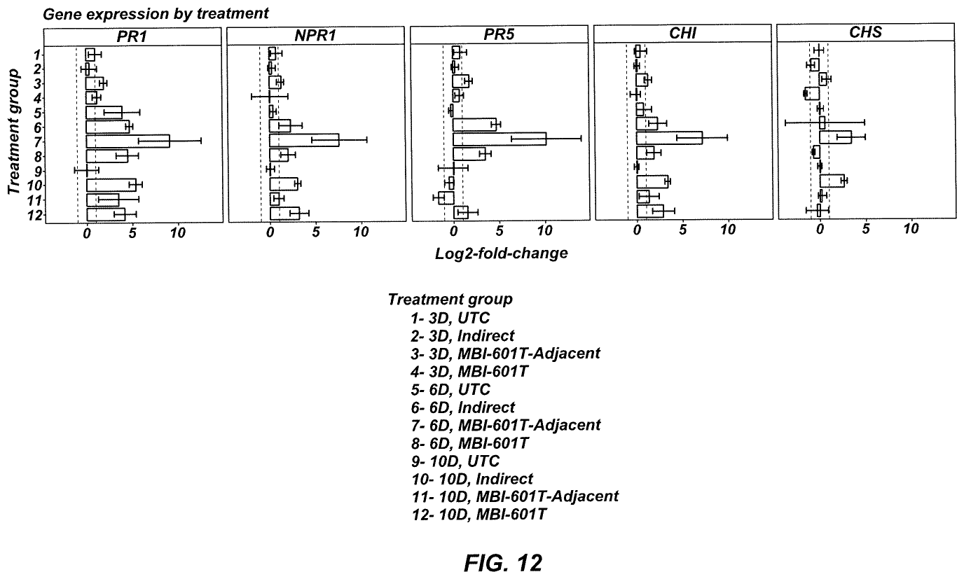

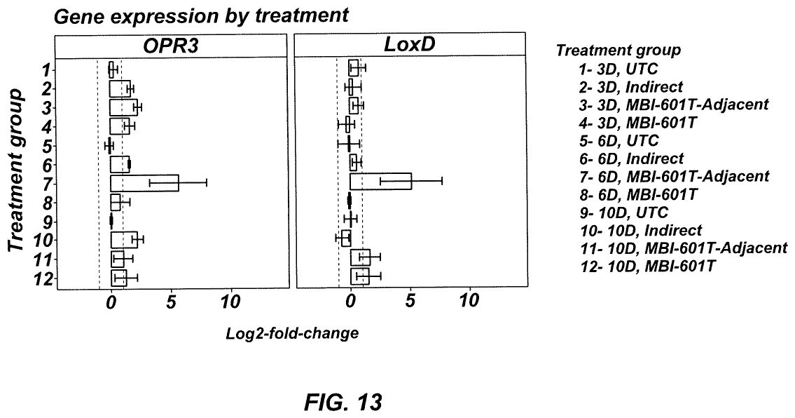

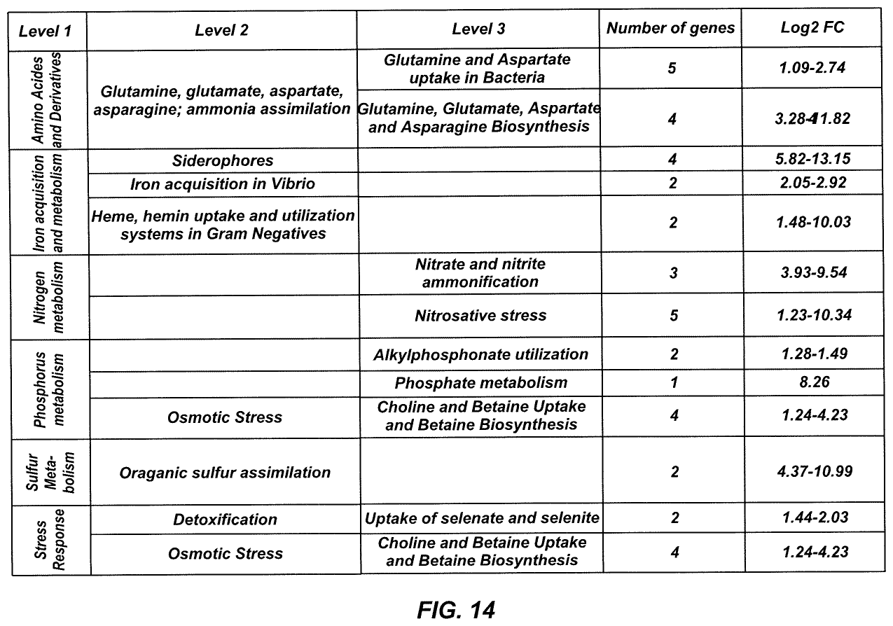

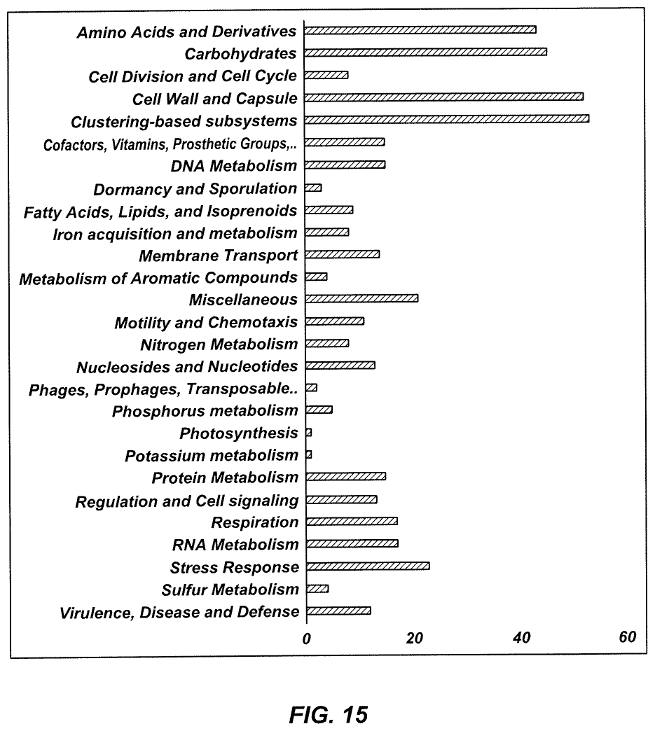

FIG. 14 summarizes the findings for expression levels of microbial pathways upregulated in the rhizosphere of MBI-601 treated plants 14 days post-treatment. FIG. 15 is a chart showing the number of genes overexpressed by the microbial community in the rhizosphere of MBI-601 treated plants 14 days post-treatment. FIGS. 16 and 17 show the relative abundance of various bacteria in the rhizosphere of treated (MBI-601) and untreated (UTC 1-3) plants.

Study 3: Effect of Muscodor albus on Strawberry Plant Growth Promotion

Four pots (11.5″) per treatment were filled with 75% standard potting soil mix (45% Topsoil-riverwash sandy soil, 5% Vermiculite, 35% Peat Moss, 15% Perlite) and 25% sand. Six separate treatment groups were studied: an untreated control group with low and high watering conditions, an MB-601 treatment group applied at the field rate with low and high watering conditions, and an MB-601 treatment group applied at a half field rate with low and high watering conditions:

| UTC | MB-601 at field rate | MB-601 at half field rate |
|---|---|---|
| Low water: No | Low water: MBI-601 | Low water: MBI-601 |
| MBI-601, watered | applied at 1.3 g/pot | applied at 0.65 g/pot |
| at 1 gallon/day | (125 lb/acre equivalent) | (62.5 lb/acre equivalent) |
| High water: No | watered at 1 gallon/day | watered at 1 gallon/day |
| MBI-601, watered | High water: MBI-601 | High water: MBI-601 |
| at 2 gallons/day | applied at 1.3 g/pot | applied at 0.65 g/pot |
| | (125 lb/acre equivalent) | (62.5 lb/acre equivalent) |
| | watered at 2 gallons/day | watered at 2 gallons/day |

MBI-601 (Batch C-220303-02) was incorporated into the soil at a rate of 1.3 g/pot (125 lb/acre equivalent) for the MB-601 at field rate, or 0.65 g/pot (62.5 lb/acre equivalent) for the MN-601 at half field rate. MBI-601 was initially hydrated to field capacity and allowed to incubate for 7 days under greenhouse conditions. After 7 days, Albion strawberries were transplanted (one per pot) and plants were maintained with normal/high water conditions (2 gallons/day) or low water conditions (1 gallon/day). The plants were analyzed with the Phenospex PlantEye multispectral 3D scanner at transplant and weekly thereafter for six weeks. After four weeks, the total number of fruit and flowers were also counted.

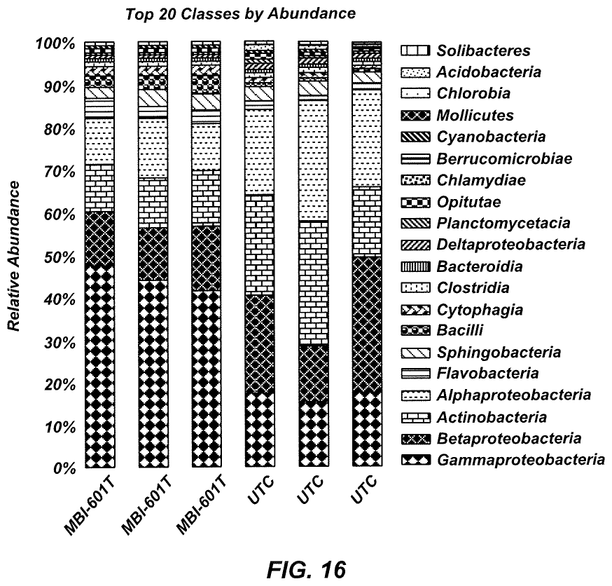

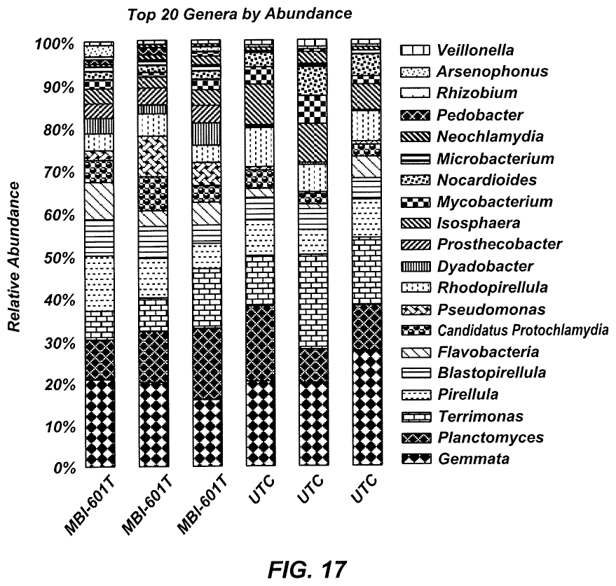

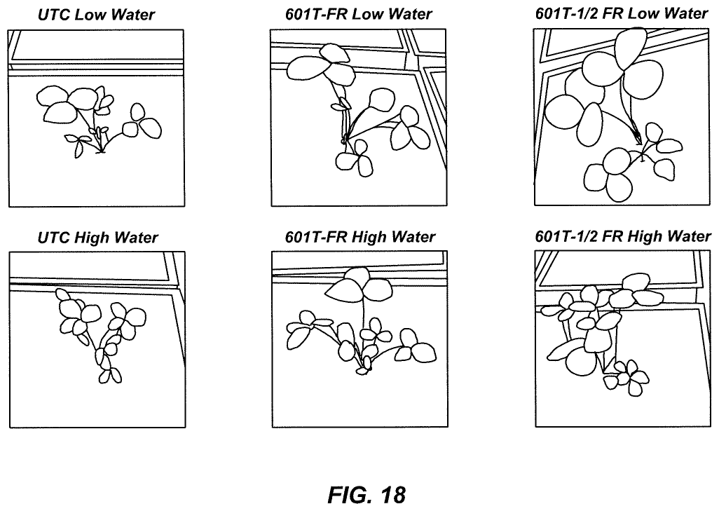

One of the purposes of this experiment was to measure the effects of Muscodor albus on fruits and flowers of strawberry plants, as well as biomass. FIG. 18 shows a photo of the plants in each of the treatment group after four weeks. FIG. 19 shows a chart of the biomass (in mm³) of the plants in the treatment groups. The data on the left of FIG. 19 shows the biomass for the plants with a low hydration rate and right shows the biomass for the plants with a high hydration rate. “0” indicates the control with no treatment, “0.5” indicates the MB-601 applied at half field rate, and “1” indicates the MB-601 applied at field rate. FIG. 20 shows the same data as FIG. 19, with plants from both hydration rates pooled together in a single graph.

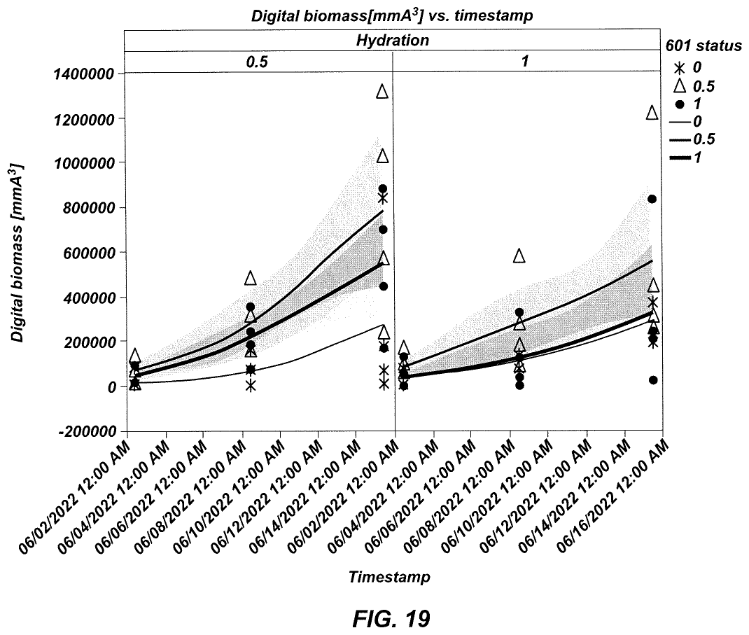

FIG. 21 shows a graph of the number of combined flowers and fruits on the plants after four weeks for each treatment group. No fruits nor flowers were present on any of the UTC plants for either low or high watering. As seen in the figures and data presented in FIGS. 18-21, plants directly exposed to Muscodor albus, and watered either at a low or a high rate, exhibited increases fruits and flowers, compared to plants not exposed to Muscodor albus (Group 1 “UTC”). Muscodor albus appears to both induce earlier flowering and increase biomass of plants.

Study 4: Field Evaluation of Muscodor albus on Leaf Mitrient Accumulation, Fresh Biomass Yield, and Soil PLFA Analysis in Broccoli

A field trial was conducted to determine the effects of Muscodor albus on leaf nutrient accumulation, fresh biomass yield, and phospholipid fatty acid (PFLA) content of soil samples. Different batches/lots of Muscodor albus treatments were prepared and applied to the field. The batches are as follows, with all batches prepared (a) using an unmalted/pearled barley from Great River Organic Milling, (b) using a fermentation or shake flask (with age) of MA′AM-11 pH uncontrolled, and (c) 1 kg as the amount prepared. For all four lots, un-malted pearled barley is sterilized for a minimum of 30 minutes before the addition of whole cell broth from fermentation. For all four lots, the barley was dried out after addition of whole cell broth in a bio safety cabinet until moisture level was below 14% as measured by a grain moisture meter.

| Lot of | | |
|---|---|---|
| Muscodor albus | Preparation | Additional |
| formulation | Method | Ingredients |
| 5-S2H | Soak, 2 hours | n/a |
| 2-R | Rinse, 5 min soak | Niacin, Thiamin, |
| | | amino acids |
| 5-ST-L | Seed Treatment | n/a |
| | 2 mL/20 g | |
| 5-ST-H | Seed Treatment | n/a |
| | 4 mL/20 g | |

Lot 5-S2H is barley prepared with end of fermentation whole cell broth run with its pH uncontrolled. The sterilized barley is soaked for 2 hours before removing excess liquid and drying.

Lot 5-ST-L is prepared as a seed treatment using the sterilized barley as the “seed” and adding 2 mL of the pH uncontrolled end of fermentation whole cell broth per 20 g of sterilized barley.

Lot 5-ST-H is prepared with the same method as 2022110-ST-L, but a higher rate of 4 mL of the pH uncontrolled end of fermentation whole cell broth per 20 g of sterilized barley.

Lot 2-R is prepared using a separate whole cell broth fermentation that is pH uncontrolled, but amino acids added to the whole cell broth at the end of fermentation (0.3 g/L Niacin, 0.3 g/L of Thiamine hydrochloride, 1.3 g/L L-Valine, and 1.2 g/L threonine). The sterilized barley was prepared with a short 5 minute soak in the whole cell broth with added amino acids before removing excess liquid and drying.

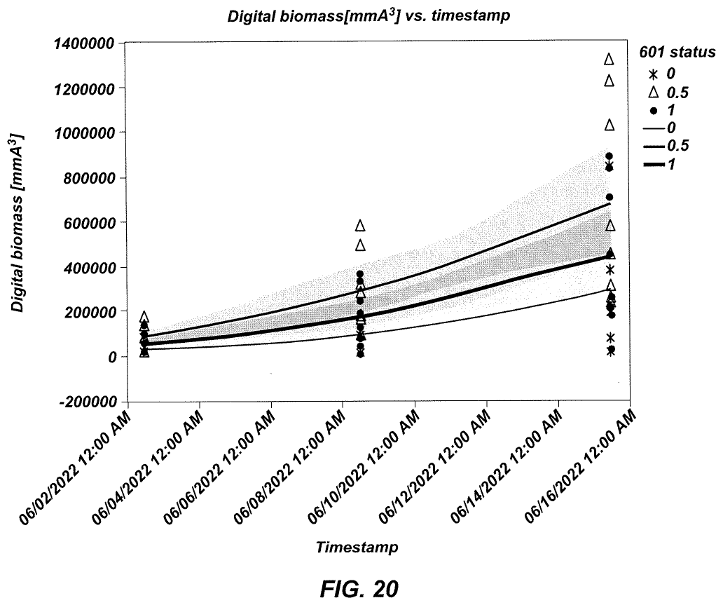

The field for treatment was separated into 1.8 meter (6 feet) plots, with 0.15 meters (½ foot) on the sides for border. The layout of the field for treatment is shown in FIG. 22. The treatments were applied to a field in the following plots at the following rates:

| Treatment | Product | Rate | | Plot |
|---|---|---|---|---|
| 1 | UTC | N/A | | A5, B6, C7, D6, E1 |
| 2 | 2-R H | 125 | lbs/a | A7, B13, C4, D1, E8 |
| 3 | 2-R M | 85 | lbs/a | A6, B10, C5, D13, E11 |
| 4 | 2-R L | 50 | lbs/a | A1, B5, C8, D2, E9 |
| 5 | 5-STL H | 125 | lbs/a | A12, B11, C11, D4, E10 |
| 6 | 5-STL M | 85 | lbs/a | A8, B8, C3, D3, E2 |
| 7 | 5-STL L | 50 | lbs/a | A10, B1, C1, D5, E4 |
| 8 | 5-STH H | 125 | lbs/a | A4, B9, C10, D7, E3 |
| 9 | 5-STH M | 85 | lbs/a | A3, B7, C6, D12, E6 |
| 10 | 5-STH L | 50 | lbs/a | A2, B3, C12, D9, E7 |
| 11 | 5-S2H H | 125 | lbs/a | A11, B4, C9, D11, E5 |
| 12 | 5-S2H M | 85 | lbs/a | A13, B2, C13, D8, E13 |
| 13 | 5-S2H L | 50 | lbs/a | A9, B12, C2, D10, E12 |

The dates of the trial included: (1) 11/10/2022, each batch lot prepared according to the table above; (2) 11/23/2022, each treatment batch applied to soil by hand and hydrated; (3) 11/30/2022, broccoli (Green Magic cultivar) transplanted into field; (4) 01/27/2023, stand count; (5) 01/25/2023, mid-season leaf nutrient analysis; (6) 04/12/2023, broccoli fresh biomass analysis; (7) 04/13/2023, broccoli harvest leaf nutrient analysis; and (8) 04/19/2023, bulk soil sampled for PLFA testing.

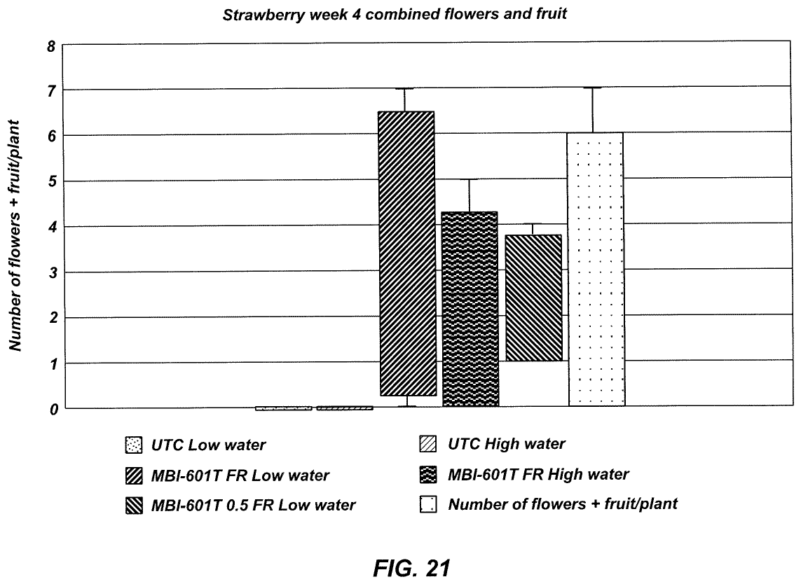

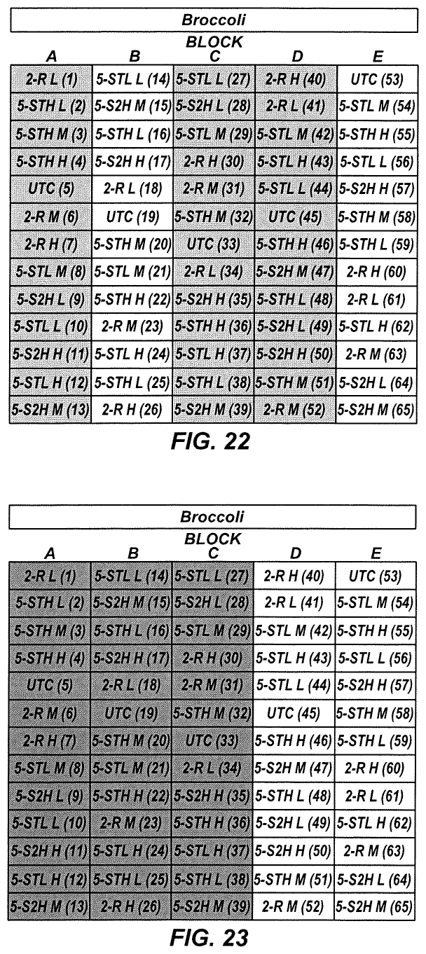

To determine broccoli fresh biomass analysis (foliar and head weight), harvest was performed on 04/12/2023. Three representative plants were sampled from a plot and the fresh biomass weight pooled. This was repeated three times. Plots chosen are highlighted in gray in FIG. 23. FIGS. 24-26 show the total average biomass (in grams) of broccoli treated at a high rate (FIG. 24, 125 lbs/acre), a medium rate (FIG. 25, 85 lbs/acre), and a low rate (FIG. 26, 50 lbs/acre) of different treatments of Muscodor albus formulations compared to a control (UTC is untreated control). Average biomass refers to the weight of the broccoli and all aboveground foliar tissue. The average biomass of the UTC was 2800 g whereas all Muscodor albus treatments exceeded 3000 g. The soak treatment (5-S2H) at both the low and medium rate (50 lbs/acre and 85 lbs/acre, respectively) resulted in the highest average biomass of 4000 g, at least 40% higher than the UTC. Other Muscodor albus treatments generally fell in the range of 18-30% biomass increase. There was no correlation between application rate and biomass as the high rate was often the least effective per treatment.

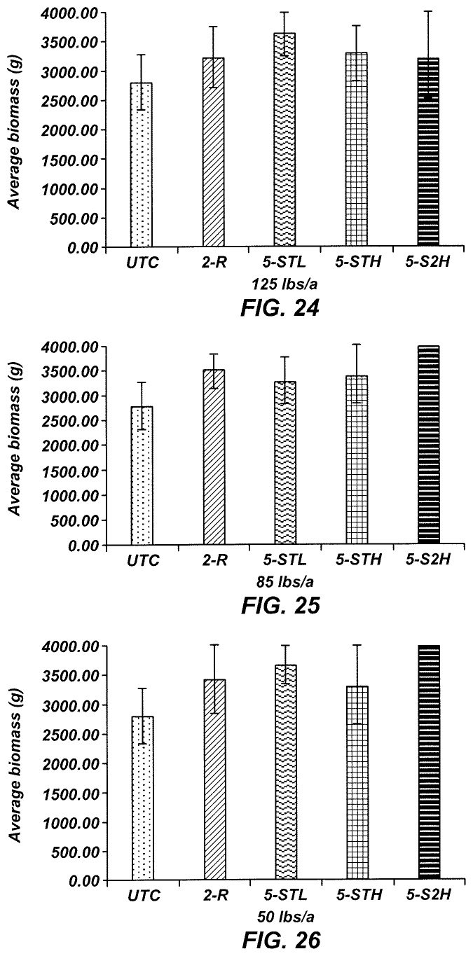

Average head weight was also measured, and FIGS. 27-29 show the total average head weight (in grams) of broccoli treated at a high rate (FIG. 27, 125 lbs/acre), a medium rate (FIG. 28, 85 lbs/acre), and a low rate (FIG. 29, 50 lbs/acre) of different treatments of Muscodor albus formulations compared to a control (UTC is untreated control). The same trends were observed when just the fresh head weight of the broccoli was measured, with the soak medium and low rate resulting in a weight of roughly 1100 g versus the UTC at 800 g. Interestingly the soak high rate results in a head weight very close to the UTC suggesting 125 lbs/acre for the soak preparation has no benefit in term of yield whereas lower rates do. Most other treatments fell in the range of a 50-150 g increase.

Additionally, leaf nutrient analysis was measured mid-season and one day after harvest. A mid-season leaf nutrient analysis was performed at the end of January to look at the effect of 601 rate application and preparation method on nutrient accumulation in the most recent fully developed leaf. Tissue was sent to Dellavalle laboratories for analysis. Below are the guidelines provided for each crop:

| Broccoli - | | | | | | | | | | | | |
|---|---|---|---|---|---|---|---|---|---|---|---|---|
| Leaf tissue | Nitrogen | Phos. | Potassium | Zinc | Manganese | Sodium | Boron | Calcium | Magnesium | Iron | Copper | Chloride |
| Normal | 3.2-5.5 | .3-.75 | 2.0-4.0 | 35+ | 25+ | <0.2 | 30-100 | 1.0-2.5 | .25-.75 | 70+ | 5-15 | NA |

In the broccoli macronutrient profile, nitrogen and phosphorous was elevated in the rinse (2-R) and seed treatment (5-ST-L and 5-ST-H) low (50 lbs/acre) treatments. In the micronutrient leaf profile, there were no significant increases conferred by Muscodor albus treatments, though iron was trending to be higher also. To summarize the key findings of the mid-season leaf nutrient analysis, Muscodor albus treatments have crop specific positive increases on: (1) nitrogen, which is critical for high yields because broccoli requires an early nitrogen supply for maximum leaf development; and (2) phosphorous, which is important during early growth, especially for root development and for flowering.

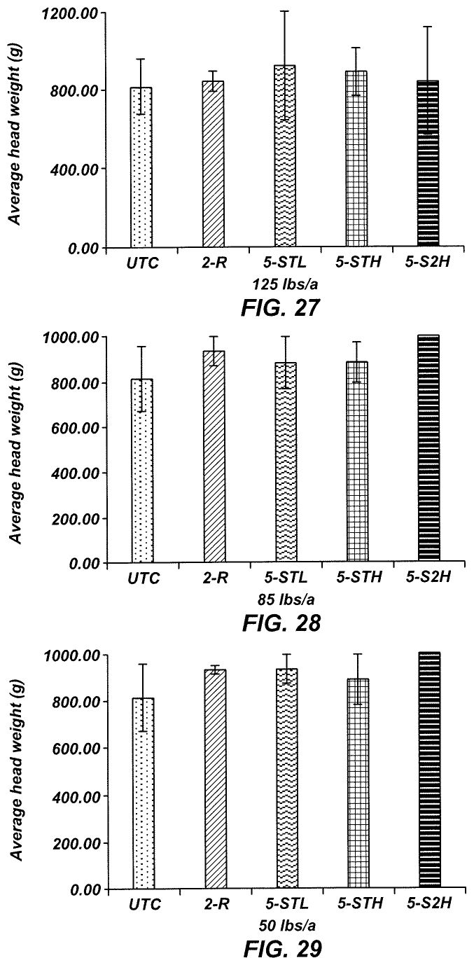

One day after harvest analysis, the most recently developed leaf (at least 10 leaves pooled per treatment) was sampled from remaining plants and sent to Dellavalle laboratories for analysis. FIGS. 30-32 show the total Nitrogen content (%) in broccoli treated at a high rate (FIG. 30, 125 lbs/acre), a medium rate (FIG. 31, 85 lbs/acre), and a low rate (FIG. 32, 50 lbs/acre) of different treatments of Muscodor albus formulations compared to a control (UTC is untreated control). There was no particular trends in terms of application rate and nutrient leaf content.

Soil health was also measured. In particular, an increase in beneficial microbes was observed. Beneficial microbes include bacteria, fungi, protozoa, endophytes, mycorrhizal fungi, nitrogen-fixers, saprophytes, and symbionts. To analyze soil health, on 04/19/2023, broccoli plants were removed, and soil was collected in the immediate vicinity of where the roots had been at the 6-8-inch depth. Only the low rate (50 lbs/acre) was analyzed for each treatment. Sampling was performed from three plants per block and soil was mixed before shipping roughly 200 g to Ward Laboratories (Kearney, NE) for phospholipid fatty acids (PLFA) analysis. PLFA gives a snapshot in time of the living microbial structure and abundance in a soil sample. The analysis process involves: (1) Lipid extraction from soil sample with a single-phase chloroform mixture, (2) Fractionation using solid phase extraction columns to isolate phospholipids, (3) Methanoanalysis of phospholipids to produce fatty acid methyl esters (FAMEs), and (4) FAME analysis by capillary gas chromatography (GC-FID).

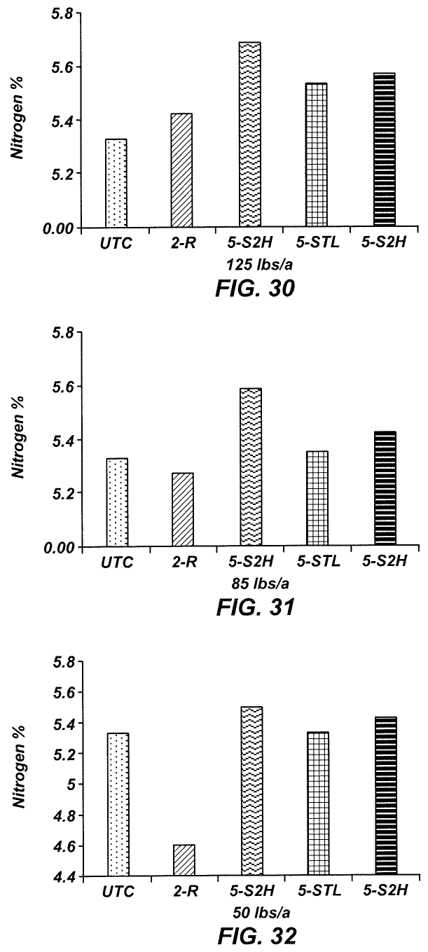

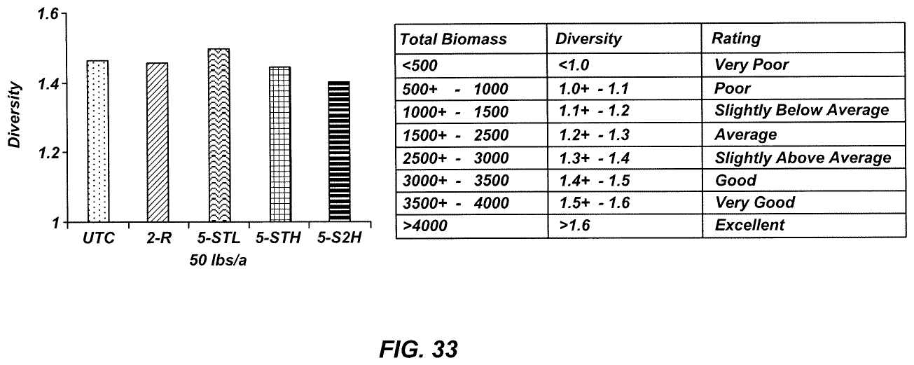

FIG. 33 shows the diversity index of soil samples taken from the rhizosphere of broccoli plants treated with 50 lbs/acre of various Muscodor albus batch formulations. Functional diversity covers the genetic variability within taxons, and the number (richness) and relative abundance (evenness) of taxons and functional groups in communities. All treatments fall under the good category and therefore Muscodor albus has no negative effects on functional diversity. FIG. 34 is the ratio of fungi to bacteria in the rhizosphere soil samples of broccoli treated at 50 lbs/acre with different batch formulations of Muscodor albus.

The rating scale for fungi to bacteria in soil typically is in the range of 0 to 1 with 1 being a highly productive soil where there is a balanced community however that is rarely the case in modern agriculture due to processes such as tilling and fertilizer application resulting in bacteria dominated soil communities. As such, conventional soils typically have a value of 0.1 to 0.3 characterized by a high Nitrogen rate and low Carbon rate favoring bacteria which are more effectively able to utilize nitrogen. All treatments (>0.35) result in a more balanced fungi to bacteria community compared to the UTC (0.3-0.35). Therefore, the fungal composition of soil is a good indicator of soil health and an increasing priority among growers. The following table is a comparison of the bacterial vs fungi rhizosphere compositions with respect to the biomass increase from UTC in broccoli treated at 50 lbs/acre with different formulations of MBI-601. The table shows that the STL-L treatment yields the most balanced fungi:bacteria community.

| 50 lbs/a | Bacteria % | Fungi % | Difference | Biomass % increase |
|---|---|---|---|---|
| UTC | 42.82 | 13.93 | 28.89 | NA |
| 2-R | 42.75 | 15.91 | 26.84 | 22.14 |
| 5-STL | 32.15 | 18.36 | 13.79 | 31.37 |
| 5-STH | 42.5 | 15.53 | 26.97 | 17.92 |
| 5-S2H | 44.2 | 18 | 26.2 | 47.81 |

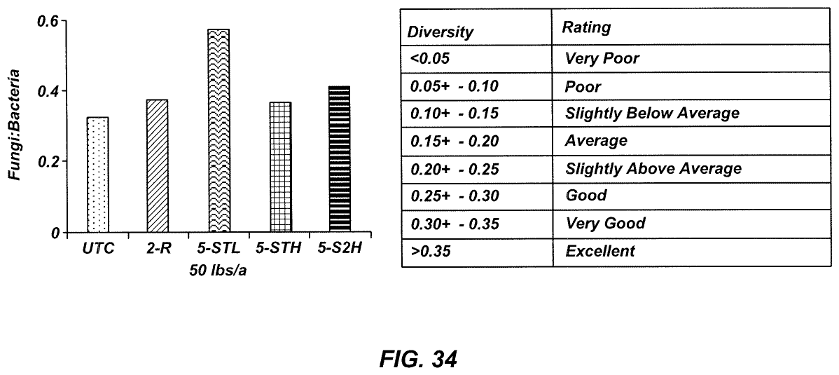

FIG. 35 shows is the total living microbial biomass in ng/g of the rhizosphere soil sample taken from broccoli treated with 50 lbs/acre of different formulations of Muscodor albus. The metric for total living microbial biomass includes: (a) Bacteria gram+(Actinomycetes) and gram—(Rhizobia); (b) Fungi (Arbuscular Mycorrhizae and Saprophytes); (c) Protozoa; and (d) Undifferentiated. All treatments except for the seed treatment high (5-STH) resulted in an increase in total living microbial biomass.

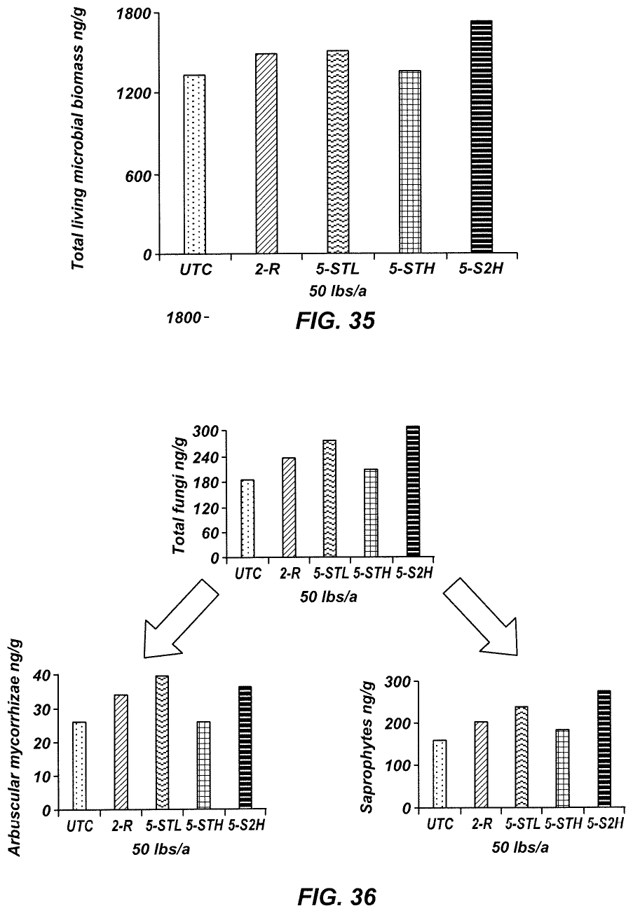

FIG. 36 shows the breakdown of total fungi into arbuscular mycorrhizae and saprophytes in the rhizosphere soil samples taken from broccoli treated with 50 lbs/acre of different formulations of Muscodor albus. All Muscodor albus treatments resulted in an increase in the total number of fungi with the soak samples yielding nearly double the fungal population compared to the UTC. There were increases in both arbuscular mycorrhizae (AM) (shown in the bottom, left graph of FIG. 36) and saprophytes (shown in the bottom, right graph of FIG. 36) with saprophytes being responsible for most of the increase in the fungal population. AM fungi play a key role in enabling better acquisition of nutrients by the plants and saprophytes recycle nutrients and prey on soil borne pathogens.

The examples above are presented to describe embodiments and utilities of the disclosure and are not meant to limit the invention unless otherwise stated in the claims appended hereto. Although this disclosure provides many specifics, these should not be construed as limiting the scope of any of the claims that follow, but merely as providing illustrations of some embodiments of elements and features of the disclosed subject matter. Other embodiments of the disclosed subject matter, and of their elements and features, may be devised which do not depart from the spirit or scope of any of the claims. Features from different embodiments may be employed in combination. Accordingly, the scope of each claim is limited only by its plain language and the legal equivalents thereto.

What is claimed:

1. A method for increasing biomass of a plant comprising the step of:
applying to the plant and/or a seed and/or a substrate used for growing said plant an effective amount of a composition comprising Muscodor albus strain SA-13 (NRRL Accession No. B-50774) fermentation.

2. The method of claim 1, wherein the method comprises applying a grain inoculated with Muscodor albus strain SA-13 to the substrate used for growing the plant.

3. The method of claim 2, wherein the composition comprising Muscodor albus strain SA-13 (NRRL Accession No. B-50774) is prepared by soaking barley in fermentation whole cell broth, removing excess liquid, and drying the barley.

4. The method of claim 1, wherein the plant is selected from: tomato, broccoli, lettuce, corn, and strawberry.

5. A method for increasing an amount of beneficial microbes in a soil, comprising the step of:
applying to the soil, to a plant grown in the soil, and/or a seed and/or a substrate used for growing a plant in the soil, an effective amount of a composition comprising Muscodor albus strain SA-13 (NRRL Accession No. B-50774) fermentation.

6. The method of claim 5, wherein the method comprises applying a grain inoculated with Muscodor albus strain SA-13 to the substrate used for growing the plant in the soil.

7. The method of claim 6, wherein the plant is broccoli.

8. The method of claim 5, wherein the composition comprising Muscodor albus strain SA-13 (NRRL Accession No. B-50774) is prepared by soaking barley in fermentation whole cell broth, removing excess liquid, and drying the barley.

9. A method for inducing early flowering in a plant, comprising the step of:
applying to the plant and/or a seed and/or a substrate used for growing said plant an effective amount of a composition comprising Muscodor albus strain SA-13 (NRRL Accession No. B-50774) fermentation.

10. The method of claim 9, wherein the method comprises applying a grain inoculated with Muscodor albus strain SA-13 to the substrate used for growing the plant.

11. The method of claim 9, wherein the composition comprising Muscodor albus strain SA-13 (NRRL Accession No. B-50774) is prepared by soaking barley in fermentation whole cell broth, removing excess liquid, and drying the barley.

12. The method of claim 9, wherein the plant is tomato, and/or strawberry.


SEQUENCE LISTING (18 sequences)

SEQ ID NO: 1 - DNA, 21 bp, Solanum lycopersicum
  source 1..21: mol_type = genomic DNA
aacgctcacaatgcagctcgt

SEQ ID NO: 2 - DNA, 20 bp, Solanum lycopersicum
  source 1..20: mol_type = genomic DNA
aaggtccaccagagtgttgc

SEQ ID NO: 3 - DNA, 18 bp, Solanum lycopersicum
  source 1..18: mol_type = genomic DNA
gggaaagatagcagcacg

SEQ ID NO: 4 - DNA, 21 bp, Solanum lycopersicum
  source 1..21: mol_type = genomic DNA
gtccacacaaacacacacatc

SEQ ID NO: 5 - DNA, 22 bp, Solanum lycopersicum
  source 1..22: mol_type = genomic DNA
cgcagggaatagaggtttggag

SEQ ID NO: 6 - DNA, 24 bp, Solanum lycopersicum
  source 1..24: mol_type = genomic DNA
agcactctcttccaagtacacacc

SEQ ID NO: 7 - DNA, 22 bp, Solanum lycopersicum
  source 1..22: mol_type = genomic DNA
gcttagtaccacaggtgaaggc

SEQ ID NO: 8 - DNA, 22 bp, Solanum lycopersicum
  source 1..22: mol_type = genomic DNA
tggagcacaacagtctcaacag

SEQ ID NO: 9 - DNA, 20 bp, Solanum lycopersicum
  source 1..20: mol_type = genomic DNA
gcaacaactgtccatacacc

SEQ ID NO: 10 - DNA, 20 bp, Solanum lycopersicum
  source 1..20: mol_type = genomic DNA
agactccaccaccaatcacc

SEQ ID NO: 11 - DNA, 22 bp, Solanum lycopersicum
  source 1..22: mol_type = genomic DNA
gactggtccaagttcacgatcc

SEQ ID NO: 12 - DNA, 25 bp, Solanum lycopersicum
  source 1..25: mol_type = genomic DNA
atgtgctgccaatataaatggttcc

SEQ ID NO: 13 - DNA, 22 bp, Solanum lycopersicum
  source 1..22: mol_type = genomic DNA
ttggcttagcagttgttgaaag

SEQ ID NO: 14 - DNA, 22 bp, Solanum lycopersicum
  source 1..22: mol_type = genomic DNA
tacgtatcgtggctgtgttaca

SEQ ID NO: 15 - DNA, 25 bp, Solanum lycopersicum
  source 1..25: mol_type = genomic DNA
ggtggaagacaagtggttggaacac

SEQ ID NO: 16 - DNA, 24 bp, Solanum lycopersicum
  source 1..24: mol_type = genomic DNA
cgtctggctgaacaaaaggattgg

SEQ ID NO: 17 - DNA, 22 bp, Solanum lycopersicum
  source 1..22: mol_type = genomic DNA
atggagtttttgagtcttctgc

SEQ ID NO: 18 - DNA, 19 bp, Solanum lycopersicum
  source 1..19: mol_type = genomic DNA
gctgcgtttctggcttagg